(19) United States
(12) Patent Application Publication
(10) Pub. No.: US 2012/0105508 A1
(43) Pub. Date: May 3, 2012

(54) BACKLIGHT DEVICE, IMAGE DISPLAY APPARATUS COMPRISING SAME, AND DRIVING METHOD

(75) Inventor: Takeshi Masuda, Osaka-shi (JP)

(73) Assignee: SHARP KABUSHIKI KAISHA, Osaka-shi, Osaka (JP)

(21) Appl. No.: 13/381,427

(22) PCT Filed: Apr. 19, 2010
(86) PCT No.: PCT/JP2010/056943

§ 371 Date: Dec. 29, 2011

(30) Foreign Application Priority Data
Oct. 20, 2009 (JP) 2009-241334

(51) Int. Cl. G09G 5/10; F21V 7/04; F21V 8/00

(52) U.S. Cl. 345/690; 362/613; 362/609; 362/612; 362/602

(57) ABSTRACT

A backlight device according to the present invention includes a lamination of two light guide layers, namely, a first light guide layer (1) and a second light guide layer (3). The first light guide layer (1) includes a plurality of first light guide sections (1a) arrayed in a vertical direction. The second light guide layer (3) includes a plurality of second light guide sections (3a) arrayed in a horizontal direction. The first light guide sections (1a) are provided correspondingly with first light sources (2) and the second light guide sections (3a) are provided correspondingly with second light source (4). These light sources are independently controlled.

### TECHNICAL FIELD

The present invention relates to a backlight device provided to an image display apparatus, and a driving method for the backlight device, more specifically, to a backlight device capable of performing an area control for emitting light selectively from a particular region, and a driving method for the backlight device.

### BACKGROUND ART

Recently, image display apparatuses using a liquid crystal display panel are widely used, as flat panel displays characterized in thin thicknesses, light weights, etc., in liquid crystal televisions, monitors, mobile phones, etc. In the liquid crystal display panels which do not emit light by themselves, an electronic latent image formed thereon is visualized by using an external illumination means. The external illumination means may be natural light, or an illumination device provided behind of or in front of the liquid crystal display panel. Especially for display apparatuses required to display in high luminance, the configuration in which an illumination device is provided behind the liquid crystal display panel is most popular. This illumination device is called a backlight.

Backlights are mainly classified into an edge light type (may be referred to as side light type), and direct type. The backlights of edge light type (side light type) include a light guide plate (which is constituted by a transparent plate), and a linear light source (typically a cold-cathode fluorescent light tube) provided along a side edge of the light guide plate. The backlights of edge light type are widely used in display apparatuses required to be thin, such as display apparatuses for personal computers etc. On the other hand, large-size liquid crystal display apparatuses such as display apparatuses for use as display monitors or television receivers, the backlights of direct type are widely used. In the backlights of direct type, the illumination device is provided directly behind the liquid crystal display panel.

Moreover, recent developments in the liquid crystal display apparatuses include the following techniques: a technique for attaining a low power consumption by improving a contrast in a liquid crystal display apparatus by dividing a display region into a plurality of regions, which are independently managed and for which luminance of a backlight is adjusted according to image data of each region thus managed; a technique for improving a moving picture display performance of a liquid crystal display apparatus by dividing a display region into a plurality of regions, which are independently managed and for which a backlight is intermittently turned on for each region in synchronization with scanning of the liquid crystal display apparatus.

In this Description of the present application, the adjustment of the luminance of the backlight per region is called area control (of the backlight).

FIG. 15 illustrates one conventional example of the area control for a backlight of direct type, which is a backlight 100 as disclosed in Patent Literature 1. The backlight 100 is provided behind the liquid crystal display panel 102 and includes LED chips 101 arrayed in matrix. The LED chips 101 are controlled independently in terms of turning ON and OFF. In the area control performed with the configuration illustrated in FIG. 15, it is necessary to provide a LED chip 101 in each of the regions in which a display region is divided. This means that an increase in the number of regions leads to an increase in the number of LED chips 101, thereby resulting in a cost problem. Moreover, the backlights of direct type inherently has a thickness limit, which prevents the image display apparatus provided with this type of backlight from being further thinner.

If the configuration as illustrated in FIG. 15 is realized by using a backlight of edge light type, the need of providing a light guide plate per region results in need of extra process.

Patent Literature 2 discloses a backlight of edge light type for solving such a problem. The configuration of Patent Literature 2 realizes the same function as the configuration of FIG. 15 by using a single light guide commonly used for each region.

FIG. 16 is a view for explaining a configuration of a backlight of edge light type, provided to the liquid crystal display apparatus disclosed in Patent Literature 2. FIG. 16 illustrates how light sources and a light guide plate are arranged from behind the light guide plate. As illustrated in FIG. 16, a back surface of a light emitting surface 221b of the light guide plate 221 is divided into 4 regions by grooves 221c parallel with an upper edge of the light guide plate 221. The 4 regions (hereinafter referred to as fragment back surfaces 221d) are arrayed in an up-down direction and are substantially equally divided. Further the fragment back surfaces 221d are halved substantially equally in a right-left direction by a groove 221c extended in the up-down direction. By providing such grooves 221c, each light emitting surface 221b of the light guide plate 221 has a back surface edged by recesses and protrusions formed by the grooves 221c. Accordingly, one fragment back surface 221d is a protrusion when viewed from a light incident surface 221a.

Moreover, in the configuration as illustrated in FIG. 16, light sources 224 are provided respectively for each protrusion formed by the grooves 221c. Thus, a light beam emitted from one light source 224 and entered into a corresponding protrusion of the light incident surface 221a is emitted from a light emitting surface 221b facing a fragment back surface 221d corresponding to the light source 224. In the configuration of FIG. 16, the light emitting surface 221b is divided into two in the right-left direction and divided into 4 in the up-down direction. Therefore, the single light incident surface 221a is provided with 8 light sources 224. Each light source 224 is controlled under command of a control device 225a, so that the 4 fragment back surfaces 221d are independently controlled in terms of luminance.

Moreover, FIG. 16 illustrates how a light beam emitted from a light source travels through a light guide plate with grooves. As illustrated in FIG. 16, a light beam L emitted from one light source 224 enters a divided surface 221d from one of regions in which the light incident surface 221a is divided, where the divided surface 221d is associated with this region of the light incident surface 221a. Then, the light beam L entered the light guide plate 221 travels forward with reflecting side surfaces (or upper and lower surfaces of the light guide plate 221) formed by the grooves 221c and the fragment back surface 221d. Part of the light beam entered the light guide plate 221 is emitted out toward the light crystal display panel (not illustrated). As such, the light beam L entered one fragment back surface 221d travels forward with reflecting up and down in the up-down direction by the grooves 221c. Therefore, almost no part of the light beam L enters into the other fragment back surface 221d. Thus, by controlling illumination of a light source 224 for entering the light beam L into a certain fragment back surface 221d, illumination of the fragment back surface 221d to which the light beam L enters from the light source 224 is controlled.

### CITATION LIST

### Patent Literatures

Patent Literature 1
Japanese Patent Application Publication, Tokukai, No. 2002-99250 (Publication Date: Apr. 5, 2002)

Patent Literature 2
Japanese Patent Application Publication, Tokukai, No. 2009-9080 (Publication Date: Jan. 15, 2009)

### Non-Patent Literature

Non-Patent Literature 1
E. H. A. Langendijk, et al., “Quantifying Contrast Improvements and Power Savings in Displays with a 2D-Dimming Backlight”, IDW '07, pp. 311-314

### SUMMARY OF INVENTION

### Technical Problem

However, in the configuration of Patent Literature 2, the light sources 224 can be provided only on right and left edges of the light incident surfaces of the light guide plate 221, and the dividing the light emitting surface in the right-left direction can be divided into two at maximum.

There is a technical paper (Non-Patent Literature 1) reporting that area control of the backlight based on the image data of each region can allow to display an image with better contrast and lower power consumption when the display region is divided into a greater number. In this point, the configuration of Patent Literature 1 has a limitation in terms of contrast improvement and reduction in power consumption, because the number of dividing the display region is limited therein.

Therefore, there is a demand for a technique for improving these properties.

### Solution to Problem

The present invention was accomplished in view of the aforementioned problem, and an object of the present invention is to provide a backlight device of area-control type capable of improving liquid crystal display apparatus in (i) contrast to be expressed on fragmented region basis according to image data, (ii) moving picture display performance, and (iii) power consumption reduction, and a driving device for the backlight device.

In order to attain the object, a backlight device according to the present invention is a backlight device configured to be capable of emitting light selectively from a certain part of a region, including: a first light guide layer having a light emitting surface on one side, and an edge section along a first direction; a second light guide layer having a light emitting surface on one side, and an edge section along a second direction perpendicular to the first direction, the first light guide layer being provided to face the light emitting surface of the second light guide layer; a plurality of first light sources arrayed along the edge section of the first light guide layer; a plurality of second light sources arrayed along the edge section of the second light guide layer; and a light source driving section for driving the first light sources independently, and driving the second light sources independently.

With this configuration, the backlight device according to the present invention is such that the first light sources arrayed in the first direction are provided to the first light guide layer, whereby the first light guides form optical paths from the edge section of the first light guide layer along the second direction perpendicular to the first direction. On the other hand, the second light sources arrayed in the second direction are provided to the second light guide layer, whereby the second light guides form optical paths from the edge section of the second light guide layer along the second direction. In the present invention, the first guide layer with the first light sources and the second light guide layer with the second light sources are laminated on each other. Thus, when the lamination is viewed from the front or behind of the backlight device, such an optical path configuration is realized that the optical paths in the second direction due to the first light sources and optical paths in the first direction due to the second light sources intersected with each other at certain points.

With such a unique optical path configuration, an m number of fragment regions can be formed in the light guide layer by independently controlling the light emission of the m number of second light sources arrayed against the light incident surface of the upper edge of the second light guide layer as illustrated in FIG. 1 for example. On the other hand, an n number of fragment regions can be formed in the light guide layer by independently controlling the light emission of the n number of first light sources arrayed against the light incident surface of the right edge of the first light guide layer. The configuration attained by laminating the first light guide layer and the second light guide layer on each other is equivalent to a conventionally-unattainable configuration in which light emitting regions fragmented as many as desired in the first and second directions by arraying the desired numbers of light sources along the light incident surface of the upper edge (and/or lower edge) of a light guide layer and along the light incident surface of the right edge (and/or ledge edge) of the light guide layer.

As described above, the backlight device according to the present invention makes it possible to divide the display region as many as desired, on the contrary to the conventional configuration in which the display region can be divided into only two. This allows to form light emitting regions fragmented into three or more.

Moreover, compared with the conventional configuration, the configuration of the present embodiment can increase the number of the fragment regions (the number of light emitting regions). This can further improve contrast to be expressed on fragmented region basis according to image data, and can also further improve the moving picture display performance of the liquid crystal display apparatus.

Moreover, the configuration of the present embodiment makes it possible to emit light only from a desired region. This can reduce the power consumption, compared with the conventional configuration in which unnecessary light sources are also turned on.

According to the configuration of the present invention, the backlight device is a so-called side edge type. Thus, the backlight device is configured to emit light locally but does not require a thick thickness. Thus, the liquid crystal display apparatus provided with the backlight device of the present invention is also enable sufficiently to be thin.

Moreover, an image display apparatus according to the present invention is an image display apparatus including: the backlight device described above; and a display panel provided to face the light emitting surface of the first light guide layer of the backlight device, the image display apparatus further including: a control section for controlling light emission of the first light sources and the second light sources of the backlight device, the control section including: an input image brightness level calculating section for determining brightness levels of an input image; and a backlight luminance level calculating section for determining output levels of the first light sources and second light sources, the backlight luminance level calculating section being configured to calculate each of light emission intensities of the first light sources and the second light sources according to the brightness levels of the input image, respectively.

According to the configuration, the first light sources and the second light sources are controlled such that the first light sources and the second light sources perform light emission with low light emission intensity for a region in which the brightness level of the input image is low, and the first light sources and the second light sources perform light emission with high light emission intensity for a region in which the brightness level of the input image is high. This attains high contrast and low power consumption in the image display apparatus.

A driving method according to the present invention for driving the first light sources and the second light sources provided in the image display apparatus having any of the aforementioned configurations is a method including: a step (A) for calculating brightness levels LEVin(p,q) of red (R), green (G), and blue (B) in a fragment region (p, q) among an m×n number of fragment regions obtained by dividing an input image in the first direction into an m number of the first light sources (m≧2), and in the second direction into an n number of the second light sources (n≧2); a step (B) for determining an output level lev_I1(p) of that one of the first light sources which is provided for a line-p fragment region corresponding to line p and including the fragment region (p, q) among fragment regions for an m number of lines obtained by dividing the first light guide layer in the first direction into the m number of the first light sources (m≧2); and a step (C) for determining an output level lev_I2(q) of that one of the second light sources which is provided for a line-q fragment region corresponding to line q and including the fragment region (p, q) among fragment regions for an n number of lines obtained by dividing the second light guide layer in the second direction into the n number of the second light sources (n≧2), the step (C) determining that the output level lev_I2(q)=0, if the LEVin(p,q) obtained by the step (A)≦an integration of a liquid crystal display panel maximum luminance level LEV_L1(p,q)max and the output level lev_I1(p) determined by the step B, where the liquid crystal display panel maximum luminance level LEV_L1(p,q)max is a maximum luminance level at the region (p, q) on the display panel, which maximum luminance level LEV_L1(p,q)max is obtained when the first light source for the line p of the first light guide layer performs light emission with a maximum output of the first light source.

In this configuration, it is so arranged that for a region in which the brightness level of the input is lower than the thus determined value among all fragment regions of the input image, the backlight luminance level calculating section turns on a first light source corresponding to this region, and for a region in which the brightness level of the input is higher than the predetermined value, the backlight luminance level calculating section turns on a first light source and a second light source corresponding to this region. This configuration contributes to lower power consumption.

For a fuller understanding of the nature and advantages of the invention, reference should be made to the ensuing detailed description taken in conjunction with the accompanying drawings.

### Advantageous Effects of Invention

As described above, a backlight device according to the present invention is a backlight device configured to be capable of emitting light selectively from a certain part of a region, including: a first light guide layer having a light emitting surface on one side, and an edge section along a first direction; a second light guide layer having a light emitting surface on one side, and an edge section along a second direction perpendicular to the first direction, the first light guide layer being provided to face the light emitting surface of the second light guide layer; a plurality of first light sources arrayed along the edge section of the first light guide layer; a plurality of second light sources arrayed along the edge section of the second light guide layer; and a light source driving section for driving the first light sources independently, and driving the second light sources independently.

Furthermore, the present invention encompasses an image display apparatus such a backlight device and a display panel, and further encompasses a method for driving the first light sources and the second light sources provided in the backlight device.

### BRIEF DESCRIPTION OF DRAWINGS

FIG. 1 is a perspective view illustrating a configuration of a backlight device according to one embodiment.

FIG. 2 is an exploded perspective view illustrating part of the backlight illustrated in FIG. 1.

FIG. 3 is a view illustrating a specific configuration of a light source driving section provided to the backlight device illustrated in FIG. 1.

FIG. 4 is a view schematically illustrating a configuration of a liquid crystal display apparatus according to one embodiment.

FIG. 5 is a schematic view illustrating a driving method for the liquid crystal display apparatus according to the embodiment and a configuration for realizing the driving method.

FIG. 6 is a view illustrating one example of an input image.

FIG. 7 is a view for explaining a driving method for the backlight device illustrated in FIG. 3.

FIG. 8 is a view illustrating a display state realized by using a backlight device in which regions are turned on independently as desired, and a liquid crystal display panel in combination.

FIG. 9 is a view illustrating another example of the backlight device.

FIG. 10 is a view illustrating still another example of the backlight device.

FIG. 11 is a view illustrating yet another example of the backlight device.

FIG. 12 is a view illustrating another embodiment of the present invention.

FIG. 13 is a view illustrating still another embodiment of the present invention.

FIG. 14 is a view illustrating yet another embodiment of the present invention.

FIG. 15 is a view illustrating a conventional configuration.

FIG. 16 is a view illustrating a conventional configuration.

### DESCRIPTION OF EMBODIMENTS

### Embodiment 1

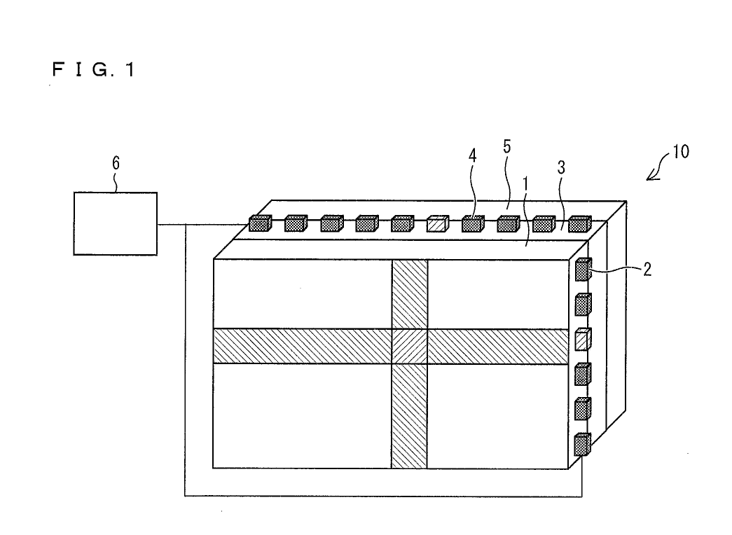

One embodiment of the present invention is described below, referring to FIGS. 1 to 4. In the present embodiment, a backlight device is one applicable as external illuminating means usable for a liquid crystal display apparatus having a function of a television receiver, or a function of displaying an image (screen image).

In the following, a configuration and an operation of a backlight device having the characteristic features of the present invention is described. And then a configuration of an image display apparatus including the backlight device is described.

[Backlight Device]

FIG. 1 is a perspective view illustrating a configuration of a backlight device according to the present embodiment. FIG. 1 illustrates the backlight device viewed from its light emitting side.

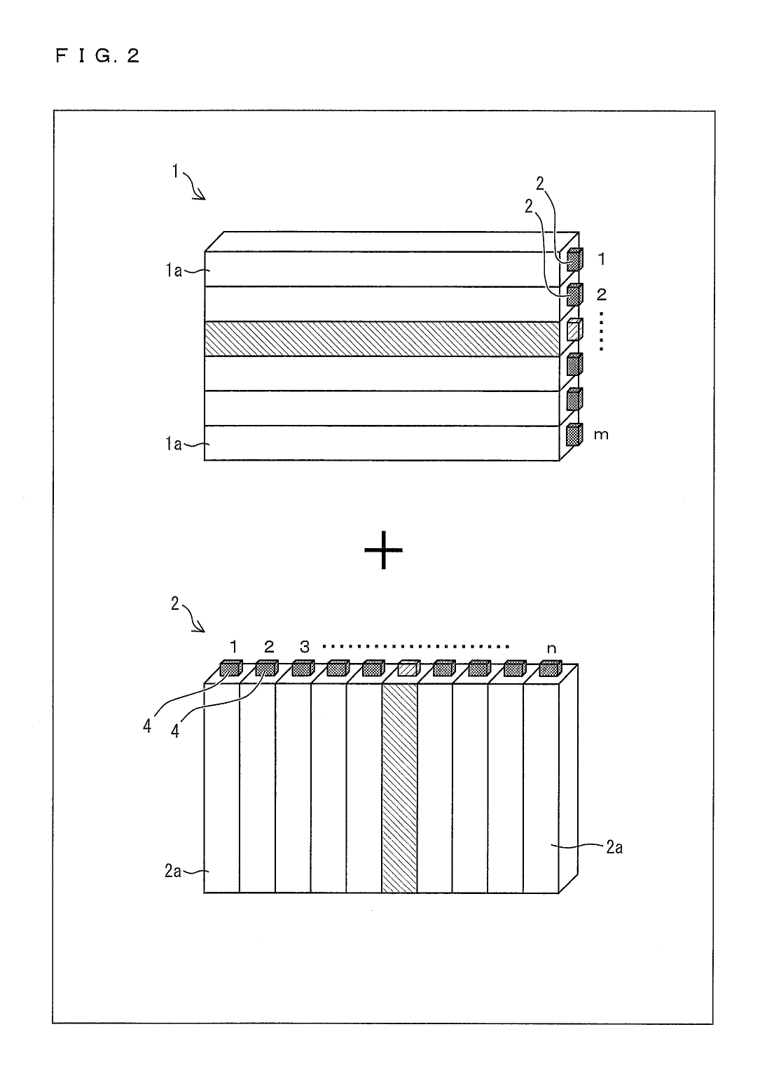

A backlight device 10 according to the present embodiment includes, as illustrated in FIG. 1, a first light guide layer 1, a first light source 2, a second light guide layer 3, a second light source 4, a reflection sheet 5, and a light source driving section 6. In the following, these members of the backlight device 10 are described, referring to FIGS. 1 and 2. FIG. 2 is an exploded perspective view illustrating part of the backlight device.

(First Light Guide Layer)

The first light guide layer 1 is made from a transparent resin such as acryl or polycarbonate, and has a function of converting into surface illumination a light beam (point light source) emitted from the first light source 2.

The first light guide layer 1 is provided to face a light emitting surface of the second light guide layer 3, as illustrated in FIG. 1. The first light guide layer 1, as illustrated in FIG. 2, includes a plurality of first light guide sections 1a having a rectangular shape or a bar-like shape being as effective as the rectangular shape. The first light guide sections 1a function as fragment regions of the first light guide layer 1, respectively.

The first light guide sections 1a are provided as many as the number of the fragment regions. That is, if the number of the fragment regions is 3 in the first light guide layer 1, 3 first light guide sections 1a identical in size in a longitudinal direction are provided. The number of the first light guide sections 1a should be 2 or more. FIG. 2 illustrates a case where an m number of first light guide sections 1a identical in size in a longitudinal direction are provided in array, thereby making it possible to provide an m number of fragment regions.

In this Description, a direction in which the first light guide sections 1a are arrayed is referred to as a “first direction”. The first direction is an up-down direction (vertical direction) of the image display apparatus (liquid crystal display panel).

One or both of edge surfaces of the first light guide 1a in its longitudinal direction can be provided with the first light source 2. That is, the one or both of the edge surfaces of the first light guide 1a are a light incident surface. In the present embodiment, one of the edge surfaces of the first light guide 1a is provided with the first light source 2.

Further, one surface of the first light guide layer 1 (which surface faces the viewer of FIG. 2) as shown in FIG. 2, in which an m number of first light guide sections 1a are assembled is a light emitting surface.

(First Light Source)

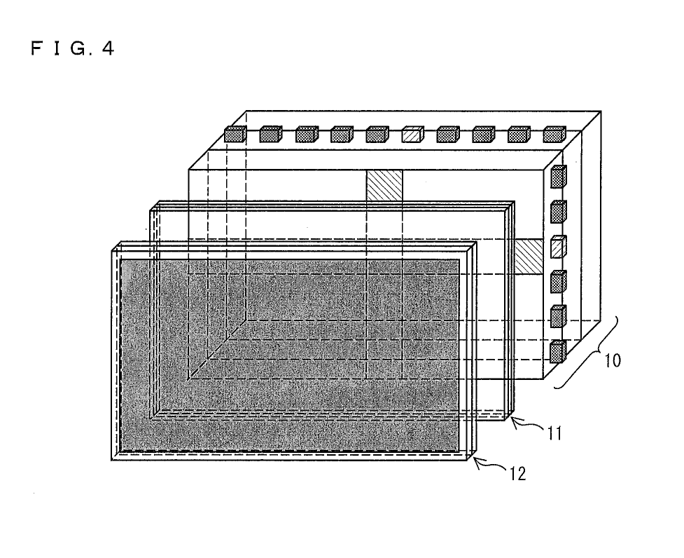

The first light sources 2, as well as the second light sources 4 later described, have a function of emitting light for image display operation of the liquid crystal display panel 12 (see FIG. 4) provided to the image display apparatus later described.

The first light sources 2 are provided respectively in the vicinity of the light incident surfaces of the corresponding first light guide sections 1a constituting the first light guide layer 1. A light beam emitted from the first light source 2 is incident on the corresponding first light guide section 1a via the light incident surface. That is, as illustrated in FIG. 2, if the number of the first light guide sections 1a is m, and each of the first light guide sections 1a is provided with one light source, then the number of the first light sources 2 is m, as well. Moreover, if each first light guide section 1a is provided with one first light source 2 on both of the edge sections, the number of the first light sources 2 is m×2.

In the following, the explanation is given based on the case where the number of the first light sources 2 is m, as illustrated in FIG. 2.

The first light sources 2 may be light sources used for general backlight devices, and for example, may be LED.

The first light sources 2 may be such that three colors, for example, (such as red (R), green (G), and blue (B)) are alternatively arranged.

It can be so configured that, the m number of first light sources 2 are provided on one substrate (for example, a ceramic substrate having a low heat resistance), so as to be electrically connectable with a wiring pattern formed on the substrate, even though this configuration is not illustrated here. A current/voltage is supplied to the m number of first light sources 2 via the wiring pattern, so as to cause the m number of first light sources 2 to emit.

Moreover, it may be so configured that a lens for appropriately scatting the emitted light is provided above a light emitting surface of each first light source 2. Moreover, the first light sources 2 may be in touch with a heat sink so that the heat generated in the m number of first light sources 2 is conducted to the heat sink effectively.

As illustrated in FIG. 2, the light beam incident on the light incident surface of a certain first light guide section 1a is propagated inside the first light guide section 1a in such a manner that the light beam is reflected repeatedly inside the first light guide section 1a while being propagated. Further, as illustrated in FIG. 1, the reflection sheet 5 is provided behind the first light guide section 1a (first light guide layer) so as to return to the first light guide 1a a light beam comes out of the total reflection state and goes out of the back surface of the first light guide section 1a. This improves light efficiency.

The light emitted from the light emitting surface of the light guide section 1a enters into the second light guide layer 3 from behind thereof, the second light guide layer 3 being provided in front of the first light guide section 1a.

The first light guide sources 2 are turned on and off under control of the light source driving section 6 later described. The turning on and off of the first light guide sources 2 is later described.

(Second Light Guide Layer)

The second light guide layer 3 is made from a transparent resin such as acryl or polycarbonate, and has a function of converting into surface illumination a light beam (point light source) emitted from the second light source 4.

The second light guide layer 3 is provided behind the first light guide layer 1 as illustrated in FIG. 1. The second light guide layer 3, as illustrated in FIG. 2, includes a plurality of second light guide sections 3a having a rectangular shape or a bar-like shape being as effective as the rectangular shape. The second light guide sections 3a function as fragment regions of the second light guide layer 3, respectively.

The second light guide sections 3a are provided as many as the number of the fragment regions. That is, if the number of the fragment regions is 3 in the second light guide layer 3, 3 second light guide sections 3a identical in size in a longitudinal direction are provided. The number of the second light guide sections 3a should be 2 or more. FIG. 2 illustrates a case where an n number of second light guide sections 3a identical in size in a longitudinal direction are provided in array, thereby making it possible to provide an n number of fragment regions.

In this Description, a direction in which the second light guide sections 3a are arrayed is referred to as a “second direction”. The second direction is a right-left direction (horizontal direction) of the image display apparatus (liquid crystal display panel).

One or both of edge surfaces of the second light guide 3a in its longitudinal direction can be provided with the second light source 4. That is, the one or both of the edge surfaces of the second light guide 3a are a light incident surface. In the present embodiment, one of the edge surfaces of the second light guide 3a is provided with the second light source 4.

Further, one surface of the second light guide layer 3 (which surface faces the viewer of FIG. 2) as shown in FIG. 2, in which an n number of second light guide sections 3a are arrayed is a light emitting surface.

It should be noted that the present invention is not limited to the present embodiment described above in which the first light guide layer 1 is provided above the light emitting surface of the second light guide layer 3. The second light guide layer 3 may be provided above the light emitting surface of the first light guide layer 1.

(Second Light Source)

The second light sources 4, as well as the first light sources 2 later described, have a function of emitting light for image display operation of the liquid crystal display panel 12 (see FIG. 4) provided to the image display apparatus later described.

The second light sources 4 are provided respectively in the vicinity of the light incident surfaces of the corresponding second light guide sections 3a constituting the second light guide layer 3. A light beam emitted from the second light source 4 is incident on the corresponding second light guide section 3a via the light incident surface. That is, as illustrated in FIG. 2, if the number of the second light guide sections 3a is n, and each of the second light guide sections 3a is provided with one light source, then the number of the second light sources 4 is n, as well. Moreover, if each second light guide section 3a is provided with one second light source 4 on both of the edge sections, the number of the second light sources 4 is n×2.

In the following, the explanation is given based on the case where the number of the second light sources 4 is n, as illustrated in FIG. 2.

The second light sources 4 may be light sources used for general backlight devices, and for example, may be LED (RGB-LED) of red (R), green (G), and blue (B).

The second light sources 4 may be such that three colors, for example, (such as red (R), green (G), and blue (B)) are alternatively arranged.

It can be so configured that, the n number of second light sources 4 are provided on one substrate (for example, a ceramic substrate having a low heat resistance), so as to be electrically connectable with a wiring pattern formed on the substrate, even though this configuration is not illustrated here. A current/voltage is supplied to the n number of second light sources 4 via the wiring pattern, so as to cause the n number of second light sources 4 to emit.

Moreover, it may be so configured that a lens for appropriately scatting the emitted light is provided above a light emitting surface of each second light source 4. Moreover, the second light sources 4 may be in touch with a/the heat sink so that the heat generated in the n number of second light sources 4 is conducted to the heat sink effectively.

As illustrated in FIG. 2, the light beam incident on the light incident surface of a certain second light guide section 3a is propagated inside the second light guide section 3a in such a manner that the light beam is reflected repeatedly inside the second light guide section 3a while being propagated. Further, as illustrated in FIG. 1, the first light guide layer 1 and the reflection sheet 5 is provided behind the second light guide section 3a (second light guide layer) so as to return to the second light guide 3a a light beam comes out of the total reflection state and goes out of the back surface of the second light guide section 3a, so as to emit the light beam from the light emitting surface (the surface facing the viewer in FIG. 2) of the second light guide section 3a.

The light emitted from the light emitting surface of the second light guide section 3a enters a back surface of an optical sheet 11 (see FIG. 4) provided in front of the second light guide section 3a.

Like the first light sources 2, the second light sources 4 are turned on and off under control of the light source driving section 6 later described. The turning on and off of the second light guide sources 4 is later described.

(Reflection Sheet)

The reflection sheet 5 is provided behind the second light guide layer 3. By the reflection sheet 5, a light beam emitted not from the light emitting surface is reflected to be returned to the first light guide section 1a or the second light guide section 3a.

The reflection sheet 5 may be a conventionally well-known reflection sheet, and may be, in general, a resin sheet such as PET (Polyethylene terephthalate), PP (polypropylene) having many cells inside thereof.

(Light Source Driving Section)

The light source driving section 6 is configured to drive the first light sources 2 and the second light sources 4, independently.

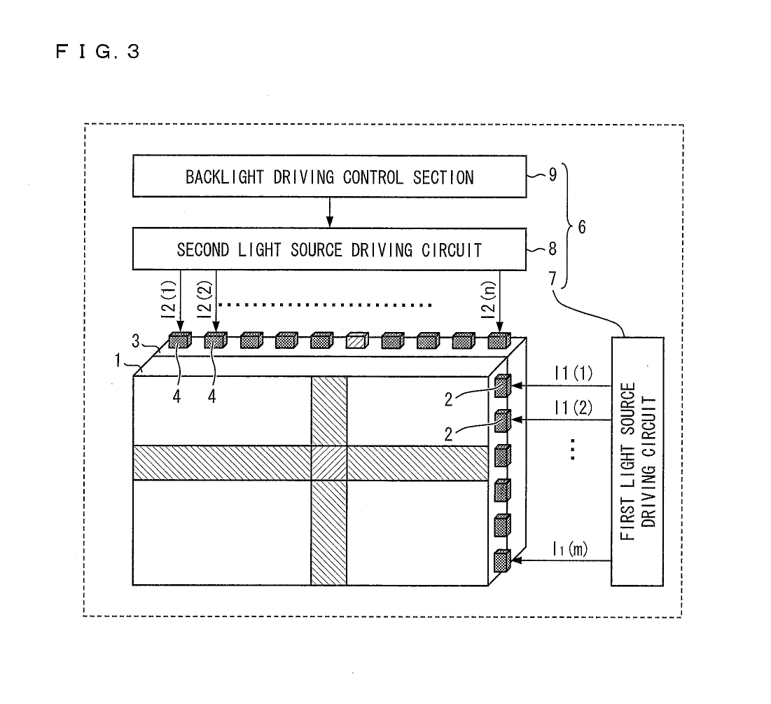

More specifically, a configuration of the light source driving section 6 is described below, referring to FIG. 3. The light source driving section 6 includes a first light source driving circuit 7 and a second light source driving circuit 8, so that the light source driving section 6 can drive the first light sources 2 and the second light sources 4. Further, the light source driving section 6 includes a backlight driving control section 9 for driving these first light source driving circuit 7 and second light source driving circuit 8.

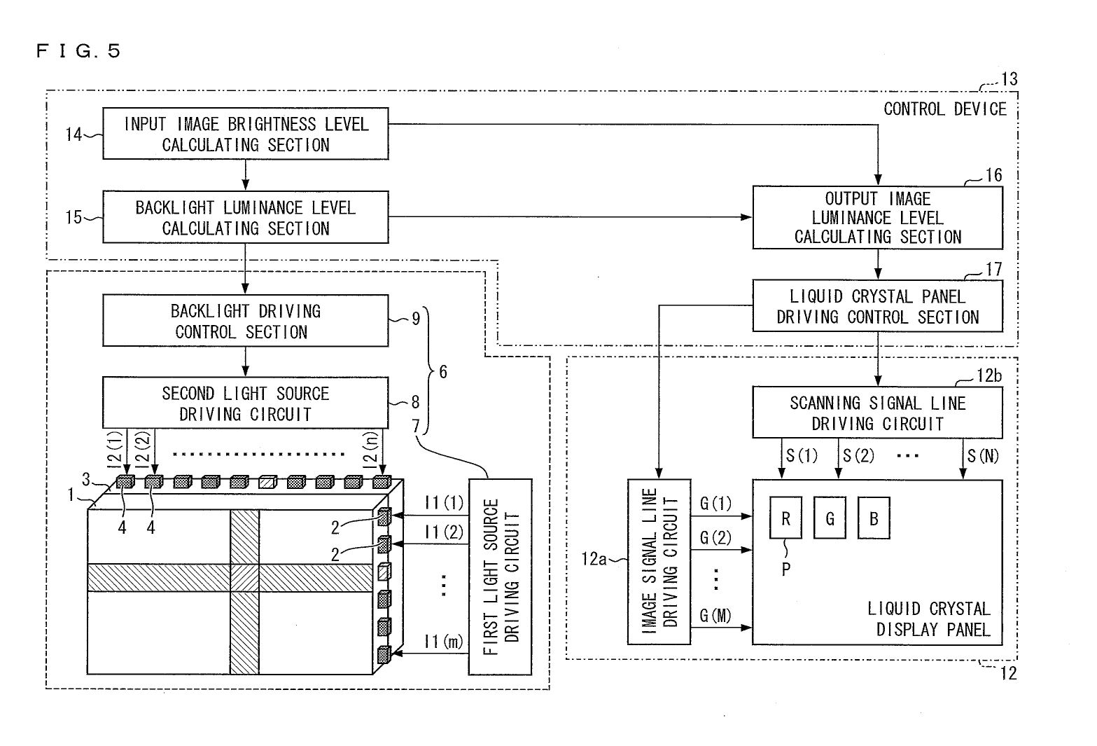

The backlight driving control section 9 of the light source driving section 6 is connected to a later-described control device 13 (see FIG. 5) of the liquid crystal display apparatus. The backlight driving control section 9 is under control of the control device 13.

Therefore, a concrete driving control mechanism for the first light sources 2 and the second light sources 4 is not explained here, but will be described when the control device 13 is described.

Next, one exemplary configuration of the image display apparatus in which the backlight device having the above configuration is mounted as external illumination means of the image display apparatus. The present embodiment is described based on an example in which the image display apparatus is a liquid crystal display apparatus.

[Image Display Apparatus]

FIG. 4 schematically illustrates a configuration of the liquid crystal display apparatus according to the present embodiment. As illustrated in FIG. 4, a liquid crystal display apparatus 20 includes the backlight device 10 as described above, the optical sheet section 11, the liquid crystal display panel 12, and the control device (not illustrated).

The liquid crystal display apparatus (image display apparatus) according to the present embodiment is provided with the backlight device 10 serving as its external illumination means for visualizing a latent image formed on the liquid crystal display panel 12. In this configuration of the liquid crystal display apparatus, the backlight device functions as the external illumination means of area control type, thereby making it possible to define regions in a display image.

In the following, the components other than the backlight device 10 having been described above are described below.

(Optical Sheet Section)

The optical sheet section 11 may be an optical sheet generally provided to a general image display apparatus, such as a diffusion sheet, a prism sheet, a refractive reflection sheet, or the like. The optical sheet section 11 may be a lamination of these sheets selected according to needs.

(Liquid Crystal Display Panel)

The liquid crystal display panel 12 includes scanning signal lines and image signal lines, which are crossed each other with an insulating film between the scanning signal lines and the image signal lines, a TFT substrate provided with, for respective pixels, TFTs and pixel electrodes, and a counter substrate on which a color filter and a common electrode are formed, and liquid crystals sealed between the TFT substrate and the counter electrode.

To the TFT substrate, a scanning signal line driving circuit 12a (see FIG. 5) on which a driver IC for driving the scanning signal lines, and an image signal line driving circuit 12b (see FIG. 5) on which a driver IC for driving the image signal lines are connected. These driving circuits are configured to output scanning signals or data signals to the predetermined scanning signal lines or the predetermined image signals lines according to predetermined signals supplied from the later-described control device to the driving circuits.

The liquid crystal display panel 12 may be provided with an optical sheet such as a polarizer sheet in front of the liquid crystal display panel 12. In case where the liquid crystal display panel 12 is provided with a polarizer sheet in front thereof, the polarizer sheet is provided in crossed Nicols with a polarizer sheet provided to the optical sheet section 11.

Next, a configuration and an operation of the control device is described, referring to FIG. 5.

(Control Device)

FIG. 5 is a schematic view illustrating a driving method for the liquid crystal display apparatus according to the present embodiment and a configuration for realizing the driving method.

The liquid crystal display apparatus according to the present embodiment is configured such that the control device 13 controls driving of the liquid crystal display panel according to an image signal obtained from an external image signal source, and controls driving of the first light sources 2 and the second light sources 4 of the backlight apparatus 10.

More specifically, the control device 13, as illustrated in FIG. 5, includes an input image brightness level calculating section 14, a backlight luminance level calculating section 15, an output image luminance level calculating section 16, and a liquid crystal display panel control section 17.

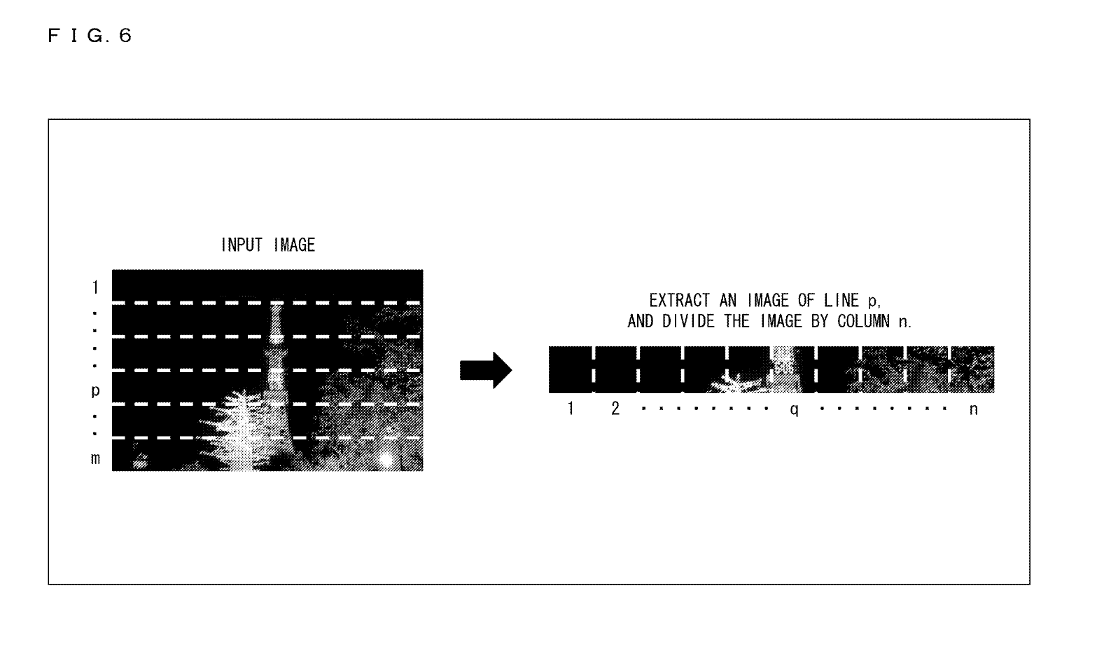

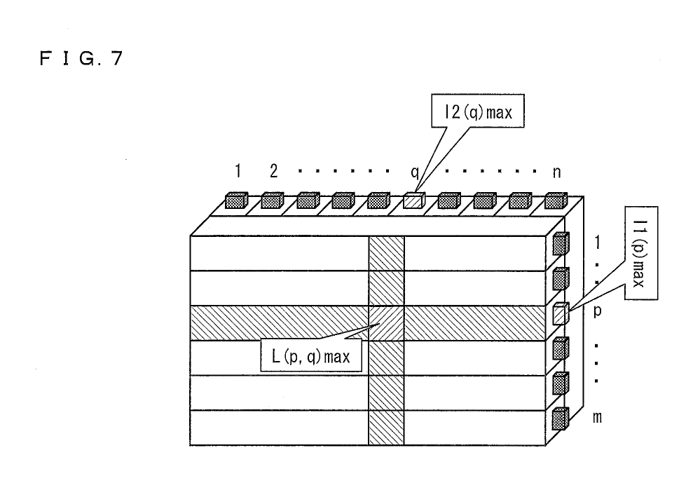

The input image brightness level calculating section 14 is configured to calculate a brightness level of an input image, based on the image signal obtained from the external image signal source. More specifically, the input image brightness level calculating section 14 receives an input image as illustrated in FIG. 6, and divides the image into the number of the first light guide sections 1a of the first light guide layer 1 (the number of the fragment regions of the first light guide layer 1). Then, the input image brightness level calculating section 14 extracts the fragment regions of the image. The input image brightness level calculating section 14 divides each divided region (FIG. 6 shows a divided region for p line) into the number of the second light guide sections 3a of the second light guide layer 3 (the number of the fragment regions of the second light guide layer 3). Then, the input image brightness level calculating section 14 extracts a brightness level (LEVin(p,q) of an image in a pixel (ip, jq) corresponding to coordinates of line p×column q of the backlight device 10 (see FIG. 7) by using following equation:

LEVin(p,q)=max(LEVin_{—}R(ip,jq),LEVin_{—}G(ip,jq),LEVin_{—}B(ip,jq))≦1

where LEVin_R(ip,jq) is a brightness level of RED components of the image (ip,jq), LEVin_G(ip,jq) is a brightness level of Green components of the image (ip,jq), and LEVin_B(ip,jq) is a brightness level of Blue components of the image (ip,jq).

Based on the LEVin(p,q) extracted by the input image brightness level calculating section 14, the backlight luminance level calculating section 15 determines, by the following procedure, an output level lev_I1(p) of a first light source 2 provided to a first light guide section 1a for line p of the first light guide layer 1.

Here, lev_I1(p) is expressed as below:

lev_{—}I1(p)=I1(p)/I1(p)max(≦1)

where I1(p)max is a maximum output of the first light source 2 provided to the first light guide section 1a for line p of the first light guide layer 1, and I1(p) is an output of the first light source 2 provided for the first light guide section 1a for line p of the first light guide layer 1.

The backlight luminance level calculating section 15 finds out which one is greater (i) the LEVin(p,q) extracted by the input image brightness level calculating section 14 or (ii) the maxim luminance level LEV_L1(p,q)max of the liquid crystal display panel at the coordinates (p, q), where the maxim luminance level LEV_L1(p,q)max is obtained when the first light source 2 for the first light guide section 1a for line p of the first light guide layer 1 performs the light emission with its maximum output I1(p)max. If the backlight luminance level calculating section 15 finds that LEVin(p,q)>LEV_L1(p,q)max, then the backlight luminance level calculating section 15 determines that LEV_L1(p,q)=LEV_L1(p,q)max. If the backlight luminance level calculating section 15 finds that LEVin(p,q)≦LEV_L1(p,q)max, then the backlight luminance level calculating section 15 determines that LEV_L1(p,q)=LEVin(p,q). Based on the LEV_L1(p,q) thus determined, the backlight luminance level calculating section 15 determines lev_I1(p) by using the following equation:

lev_{—}I1(p,q)=LEV_{—}I1(p,q)/LEV_{—}I1(p,q)max(≦1)lev_{—}I1(p)=max(lev_{—}I1(p,1),lev_{—}I1(p,2), . . . ,lev_{—}I1(p,q), . . . ,lev_{—}I1(p,n))

where lev_I1(p) is a largest one among lev_I1(p,1) to lev_I1(p,n). This is because if the lev_I1(p) is lower than the maximum value, a sufficient luminance cannot be obtained in a region exceeding lev_I1(p).

LEV_L1(p,q)max=L1(p,q)max/L(p,q)max, where L1(p,q)max is a maximum luminance of the liquid crystal display panel at the coordinates (p, q) where the maximum luminance is obtained when the first light source 2 for the first light guide section 1a for line p of the first light guide layer 1 performs the light emission with its maximum output I1(p)max.

L (p,q)max=L1(p,q)max+L2(p,q)max, where L2(p,q)max is a maximum luminance of the liquid crystal display panel at the coordinates (p, q) where the maximum luminance is obtained when the second light source 4 for the second light guide section 3a for line q of the second light guide layer 3 performs the light emission with its maximum output I2(p)max.

Further, the backlight luminance level calculating section 15 determines, by the following procedure, an output level lev_I2(q) of the second light source 4 provided for the second light guide section 3a for column q of the second light guide layer 3.

Here, lev_I2(q)=I2(q)/I2(q)max(≧1), where I2(q) is an output of the second light source 4 for the second light guide section 3a for line q of the second light guide layer 3, and I2(q)max is a maximum output of the second light source 4 for the second light guide section 3a for line q of the second light guide layer 3.

The backlight luminance level calculating section 15 finds out which one is greater (i) LEV_L1(p,q)max·lev_I1(p) (luminance level at the coordinates (p, q) of the first light guide section 1a for line p of the first light guide layer 1, and (ii) LEVin(p,q) extracted by the input image brightness level calculating section 14. If the backlight luminance level calculating section 15 finds that LEVin(p,q)>(LEV_L1(p,q)max·lev_I1(p)), then the backlight luminance level calculating section 15 determines that LEV_L2(p,q)=LEVin(p,q)-LEV_L1(p,q)max·lev_I1(p). If the backlight luminance level calculating section 15 finds that LEVin(p,q) (LEV_L1(p,q)max·lev_I1(p)), then the backlight luminance level calculating section 15 determines that LEV_L2(p,q)=0. Based on LEV_L2(p,q) thus determined, the backlight luminance level calculating section 15 determines lev_I2(p,q) by using the following equation:

lev_{—}I2(p,q)=LEV_{—}L2(p,q)/LEV_{—}L2(p,q)max(≦1)lev_{—}I2(q)=max(lev_{—}I2(1,q),lev_{—}I2(2,q), . . . ,lev_{—}I2(p,q), . . . ,lev_{—}I2(m,q))

In this manner, the backlight luminance level calculating section 15 determines the output level lev_I1(p) of the first light source 2 provided for the first light guide section 1a for line p of the first light guide layer 1, and the output level lev_I2(p,q) of the second light source 4 provided for the second light guide section 3a for column q of the second light guide layer 3. Then, the backlight luminance level calculating section 15 sends the output levels lev_I1(p) and lev_I2(p,q) to the backlight driving control section 9 of the light source driving section 6.

Then, the backlight driving control section 9 controls the first light source driving circuit 7 and the second light source driving circuit 8 for independently controlling and driving the first light sources 2 and the second light sources 4, respectively. Thereby, the backlight driving control section 9 causes the first light sources 2 and the second light sources 4 to turn on via the first light source driving circuit 7 and the second light source driving circuit 8.

On the other hand, the output image luminance level calculating section 16, which receives the signal from the input image brightness level calculating section 14, determines luminance levels of an output image (to be displayed on the liquid crystal display panel 12) by using the lev_I1(p) and lev_I2(q) determined by the backlight luminance level section 15.

The output image luminance level calculating section 16 calculates a liquid crystal display panel luminance level distribution LSF(i,j) by suing the following equation:

$$LSF ( i , j ) = {\sum }_{p = 1}^{m} LSF 1 ( p ) ( i , j ) max \cdot lev\_I 1 ( p ) + {\sum }_{q = 1}^{n} LSF 2 ( q ) ( i , j ) max \cdot lev\_I 2 ( q ) \qquad [ Math . 1 ]$$

where (i,j) is a pixel position on the liquid crystal display panel, which pixel position corresponds to a divided position (p,q) of the backlight device 10.

Moreover, the output image luminance level calculating section 16 also determines a luminance level LEVout(i,j) of the output image for the liquid crystal display panel by using the following relational expression:

LEVout_{—}R(i,j)=LEVin_{—}R(i,j)·LSF(i,j)max/LSF(i,j)LEVout_{—}G(i,j)=LEVin_{—}G(i,j)·LSF(i,j)max/LSF(i,j)LEVout_{—}B(i,j)=LEVin_{—}B(i,j)·LSF(i,j)max/LSF(i,j)

where:

LEVin_R (i,j) is a luminance level of a RED component of the pixel (i,j);

LEVin_G (i,j) is a luminance level of a GREEN component of the pixel (i,j); and

LEVin_B (i,j) is a luminance level of a BLUE component of the pixel (i,j).

LSF(i,j)max is calculated by the following equation:

$$LSF ( i , j ) max = {\sum }_{p = 1}^{m} LSF 1 ( p ) ( i , j ) max + {\sum }_{q = 1}^{n} LSF 2 ( q ) ( i , j ) max \qquad [ Math . 2 ]$$

where LSF1(p)(i,j)max and LSF2(q)(i,j)max are positional functions at the pixel position (i,j) of the liquid crystal display panel, and LSF1(p)(i,j)max is a liquid crystal display panel luminance distribution on the liquid crystal display panel, which luminance distribution is obtained when the first light source 2 for the first light guide section 1a for line p of the first light guide layer 1 performs the light emission with I1(p)max. LSF1(p)(i,j)max is a positional function at the pixel position (i,j) of the liquid crystal display panel, and LSF2(q)(i,j)max is a liquid crystal display panel luminance distribution on the liquid crystal display panel, which luminance distribution is obtained when the second light source 4 for the second light guide section 3a for column q of the second light guide layer 3 performs the light emission with I1(p)max.

In this manner, the output image luminance level calculating section 16 determines the output image luminance level of each pixel. Based on the output image luminance level of each pixel, the liquid crystal display panel driving control section 17 controls the scanning signal line driving circuit 12a and the image signal line driving circuit 12b, thereby causing the liquid crystal display panel 12 to display an image thereon.

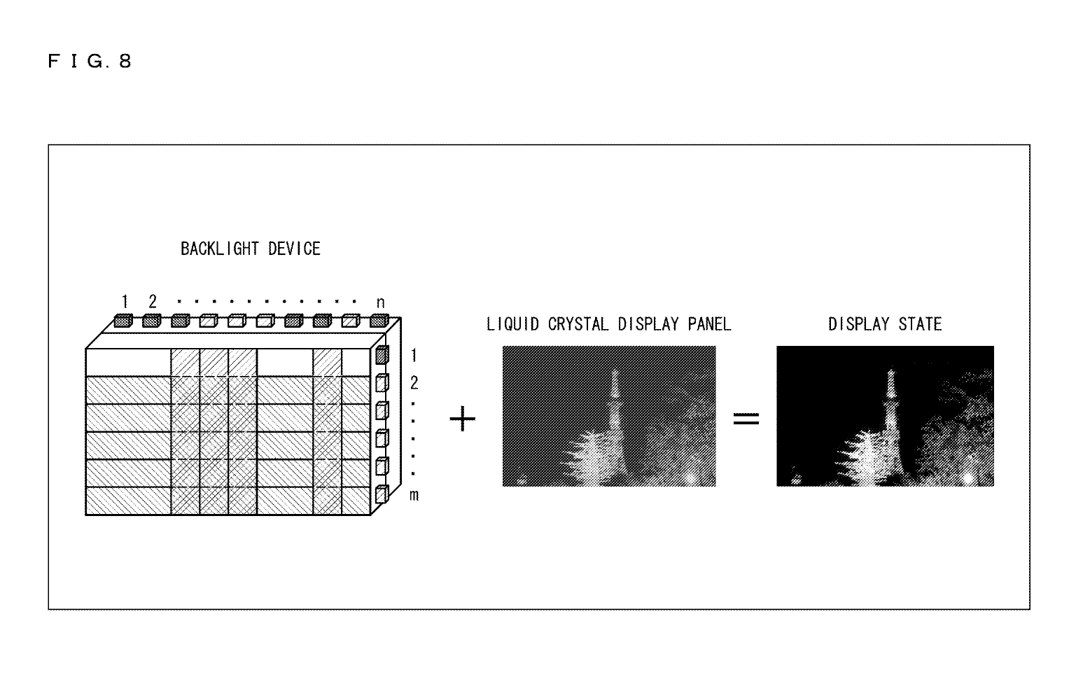

FIG. 8 illustrates a display state realized by using a backlight device in which regions are turned on independently as desired, and a liquid crystal display panel in combination.

The liquid crystal display apparatus according to the present embodiment, in which the (m+n) number of light sources are provided so that the luminance of the backlight device 10 can be controlled in the (m+n) number of regions independently. The liquid crystal display apparatus according to the present embodiment is simple in configuration but is capable of performing more fragmented control.

Moreover, by controlling the luminance distribution of the backlight according to the input image by performing the procedures described above, it is possible to attain higher contrast and lower power consumption in the liquid crystal display apparatus.

### Effects and Advantages of the Present Embodiment

In the backlight device according to the present embodiment and the liquid crystal display apparatus provided with the same, the first light guide layer 1 is provided with the first light sources 2 arrayed along the first direction, whereby the first light sources 2 form optical paths extended from the edges of the first guide layer 1 in the second direction perpendicular to the first direction. On the other hand, the second light guide layer 3 is provided with the second light sources 4 arrayed along the second direction, whereby the second light sources 4 form optical paths extended from the edges of the second guide layer 3 in the first direction perpendicular to the second direction. The first guide layer 1 with the first light sources 2 and the second light guide layer 3 with the second light sources 4 are laminated on each other. Thus, when the lamination is viewed from the front or behind of the backlight device 10, such an optical path configuration is realized that the optical paths in the second direction due to the first light sources 2 and optical paths in the first direction due to the second light sources 4 intersected with each other at certain points.

With such a characteristic optical path configuration, an m number of fragment regions can be formed in the light guide layer by independently controlling the light emission of the m number of second light sources 4 arrayed against the light incident surface of the upper edge of the second light guide layer 3 as illustrated in FIG. 1 for example. On the other hand, an n number of fragment regions can be formed in the light guide layer by independently controlling the light emission of the n number of first light sources 2 arrayed against the light incident surface of the right edge of the first light guide layer 1. The configuration attained by laminating the first light guide layer 1 and the second light guide layer 3 on each other is equivalent to a conventionally-unattainable configuration in which light emitting regions fragmented as many as desired in the first and second directions by arraying the desired numbers of light sources along the light incident surface of the upper edge (and/or lower edge) of a light guide layer and along the light incident surface of the right edge (and/or ledge edge) of the light guide layer.

As described above, the configuration of the backlight device 10 of the present embodiment makes it possible to divide the display region as many as desired, on the contrary to the conventional configuration in which the display region can be divided into only two. This allows to form light emitting regions fragmented into three or more.

Moreover, compared with the conventional configuration, the configuration of the present embodiment can increase the number of the fragment regions (the number of light emitting regions). This can further improve contrast to be expressed on fragmented region basis according to image data, and can also further improve the moving picture display performance of the liquid crystal display apparatus.

Moreover, the configuration of the present embodiment makes it possible to emit light only from a desired region. This can reduce the power consumption, compared with the conventional configuration in which unnecessary light sources are also turned on.

The backlight device 10 according to the present embodiment is a so-called side edge type. Thus, the backlight device 10 is configured to emit light locally but does not require a thick thickness. Thus, the liquid crystal display apparatus provided with the backlight device 10 of the present embodiment is also enable sufficiently to be thin.

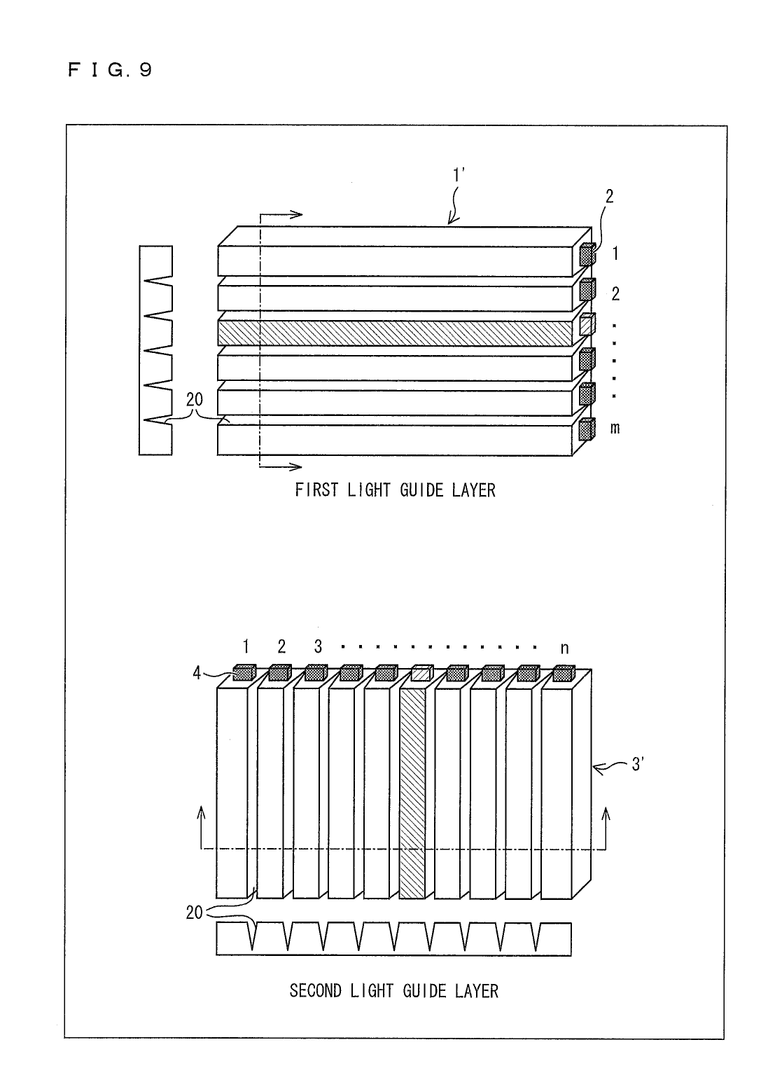

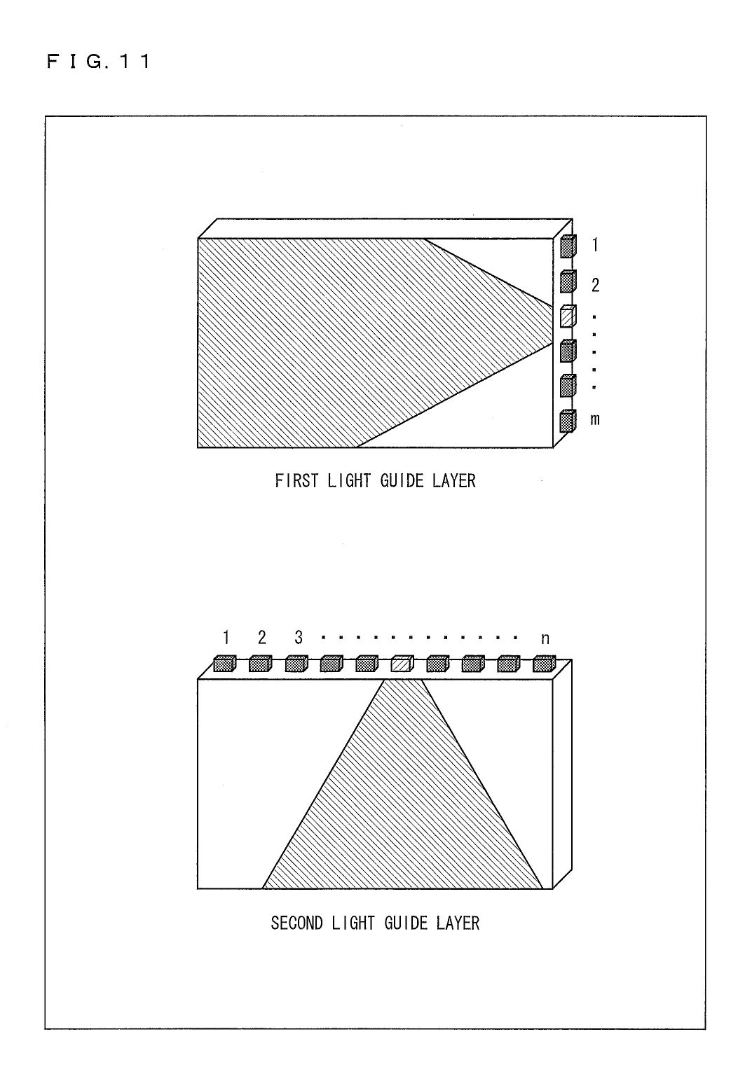

Moreover, the present invention is not limited to the backlight device 10 explained in the present embodiment in which the first light guide layer 1 and the second light guide layer 3 are provided with the light sources on only one edge surface. For example, the first light guide layer 1 can be provided with the light sources on both of the right and left edges. Moreover, for example, the first light guide layer 1 may be provided with different or identical numbers of the light sources on one edge (right edge) and the other edge (left). In the following, modifications other than this are explained, referring to FIGS. 9 to 11.

(Modifications of Backlight Device)

FIG. 9 illustrates the first light guide layer 1 and the second light guide layer 3 in the same manner as in FIG. 2. The 2 light guide layers provided to a backlight device of the present invention are not limited to the configuration illustrated in FIG. 2. More specifically, as illustrated in FIG. 9, the light guide layers may be a first light guide layer 1′ and a second light guide layer 3′, each of which is a light guide plate having grooves 18 at positions defining fragment regions of the light guide layer. Also in such a configuration, each light source is optically independent while expansion of illumination light emitted from each light source is restricted locally. Thus, the first light guide layer 1′ and the second light guide layer 3′ can function equivalently to the first light guide layer 1 and the second light guide layer 3 shown in FIG. 2. In the configuration of FIG. 9, the first light guide layer 1′ and the second light guide layer 3′ are formed by forming the grooves on each light guide plate. This simplifies assembling of the backlight device, compared with the configuration of FIG. 2.

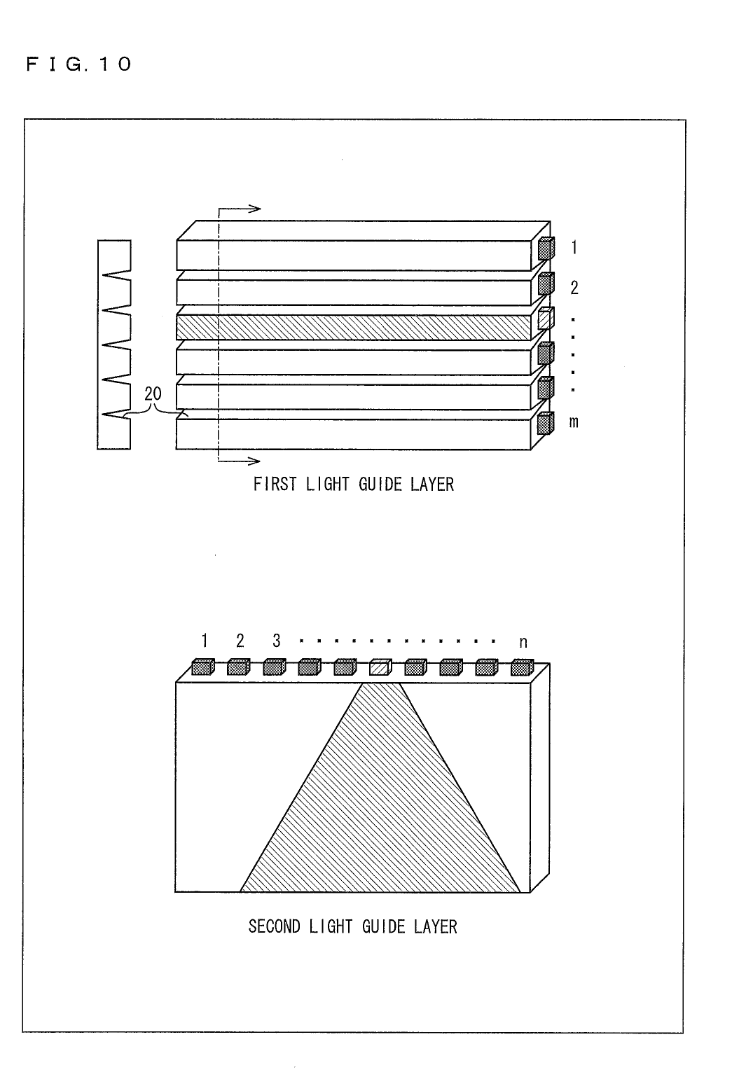

FIG. 10 illustrate still another example, in which a first light guide layer is divided into an m number of lines in the horizontal direction by forming grooves, but a second light guide layer is a light guide plate without grooves.

That is, in the still another example illustrated in FIG. 10, only the first light guide layer has optical independency. Moreover, in a configuration in which only one of the light guide layer has optical independency as illustrated in FIG. 10, it is preferable that the light guide layer with the optical independency (the first light guide layer in FIG. 10) is provided between the liquid crystal display panel and another light guide layer (the second light guide layer in FIG. 10). This is because the moving picture display performance of the liquid crystal display apparatus can be further improved when the illumination light from the horizontally fragmented regions has a greater optical independency.

As yet another example, both of a first light guide layer and a second light guide layer may be formed from one light guide plate, regardless of the number of light sources. In this example, however, optical independency is not as much as the one in the present embodiment described above and in the modifications described above. Thus, the illumination light is expanded inside the first light guide layer and the second light guide layer without local restriction, thereby making it more difficult to perform the strict area control. However, this example is more advantageous than the conventional configuration in that light beams having optical paths extended in the horizontal direction and light beams having optical paths extended in the vertical direction are formed by the two light guide layers, and the area control can be performed by crossing these light beams.

### Embodiment 2

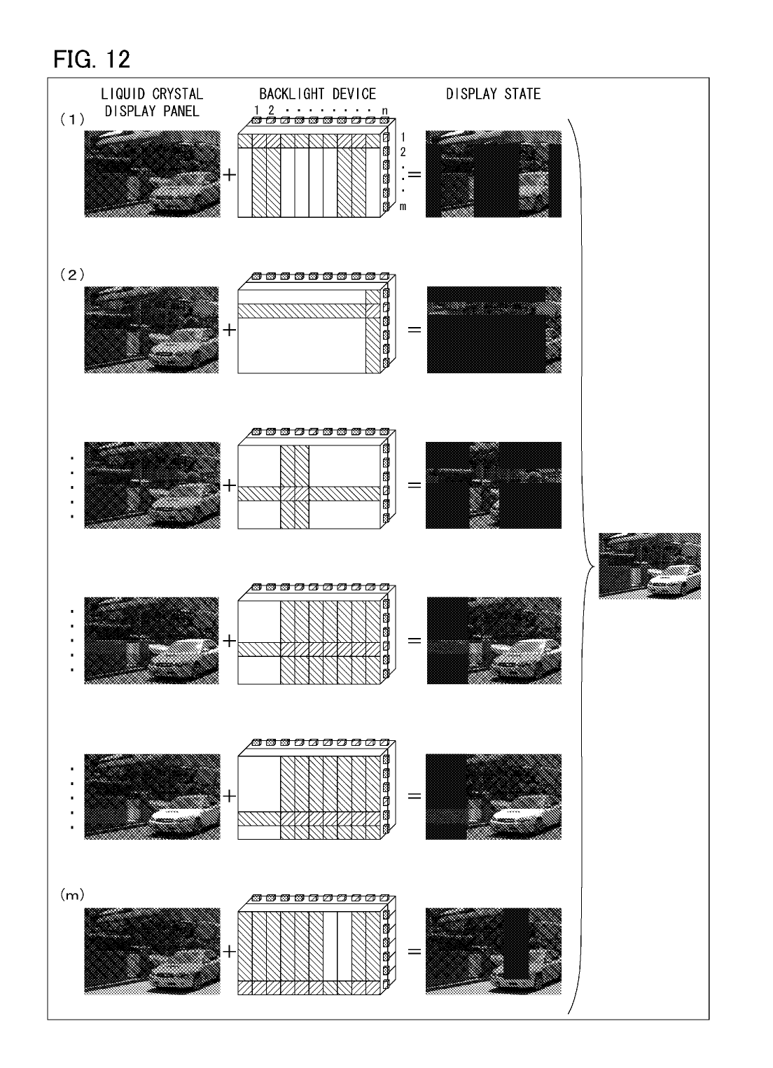

Another embodiment according to the present invention is described, referring to FIG. 12. In the present embodiment, only what is different from Embodiment 1 is described and the like member having the like functions as explained in Embodiment 1 are labeled in the same manner and their explanation is not repeated here, for the sake of easy explanation.

FIG. 12 illustrates states of a backlight device and a liquid crystal display panel of the present embodiment provided to a liquid crystal display apparatus, and display states obtained by using the backlight device and a liquid crystal display panel in combination.

Embodiment 2 is different from Embodiment 1 in how to control driving of the backlight device.

More specifically, in a first light guide layer 1, 1st to m-th light sources are turned on in synchronism with scanning of a liquid crystal display panel 12.

Further, luminance intensity (intensity of illumination light inside the light guide) of these first light sources 2 that are turned on is controlled based on image data for a region to be illuminated.

On the other hand, in a second light guide layer 3, illumination intensity (intensity of illumination light inside the light guide) of 1st to n-th light sources is controlled based on the image data in the regions illuminated by the first light sources 2 turned on for the first light guide layer 1.

Such control is performed by a control device 13 (see FIG. 5) provided to the liquid crystal display apparatus. The control device 13 of the present embodiment is different from the control device 13 of Embodiment 1 in that output level lev_I2(q) of the second light sources 4 provides for the second light guide section 3a for column 1 of the second light guide layer 3 is determined by using a different equation in the present embodiment. In the present embodiment, lev_I2(q) is determined without using the following relational equation in Embodiment 1:

lev_{—}I2(q)=max(lev_{—}I2(1,q),lev_{—}I2(2,q), . . . ,lev_{—}I2(p,q), . . . ,lev_{—}I2(m,q))

This is because, in the present embodiment, the scanning is performed on turning-on of the backlight device, and therefore the second light sources 4 provided for the second light guide section 3a for column q of the second light guide layer 3 can be controlled only in consideration of luminance level of the first light guide section 1a of the column p of the first light guide layer 1.

According to the present embodiment, the regions to be illuminated in the first light guide layer 1 are scanned in synchronism with scanning of the liquid crystal display panel 12. Thus, the liquid crystal display apparatus of hold-type display method can make advances toward an impulse type display method, and can be improved in terms of moving picture display performance.

Moreover, the intensity of the illumination light inside the light guides is controlled based on the image data. Thus, the intensity of the illumination light in regions corresponding to dark image can be reduced, thereby making it possible to realize a liquid crystal display apparatus high in contrast and low in power consumption.

### Embodiment 3

Still another embodiment according to the present invention is described below. In the present embodiment, only what is different from Embodiment 1 is described and the like member having the like functions as explained in Embodiment 1 are labeled in the same manner and their explanation is not repeated here, for the sake of easy explanation.

A liquid crystal display apparatus according to the present embodiment is different from Embodiment 1 in that first light sources and second light sources of a backlight device are RGB-LED, and outputs of these light sources are adjusted on color basis according to an input image by a control device 13 (see FIG. 1) provided to the liquid crystal display apparatus.

Compared with cases where the outputs of the light sources are adjusted irrespective of colors no matter if the light sources are white light sources (LED) or RGB light sources (LED), this configuration can achieve a greater color reproduction range, and further reduce power consumption.

In the following, a concrete control method of the control device is described. Here, the explanation is made only for R among RGB, and explanation of G and B, which are controlled in the same way as R, is omitted here.

A luminance level of R of the backlight device is determined in the following procedure.

By an input image brightness level calculating section 14 (see FIG. 5) of the control device 13, the luminance level LEVin_R(p,q) of R of an image at a pixel (ip, jq) corresponding to coordinates of line p and column q of the backlight is extracted:

LEVin_{—}R(p,q)=max(LEVin_{—}R(ip,jq))≦1

Next, a backlight luminance level calculating section 15 (FIG. 5) determines an output level lev_RI1(p) of a R color first light guide 2 for a first light guide section 1a for line p of the first light guide layer 1 in the following procedure.

The backlight luminance level calculating section 15 finds out which one is greater (i) the LEVin_R(p,q) extracted by the input image brightness level calculating section 14 or (ii) the maxim luminance level LEV_RL1(p,q)max of the liquid crystal display panel at the coordinates (p, q), where the maxim luminance level LEV_RL1(p,q)max is obtained when the first light source 2 for the first light guide section 1a for line p of the first light guide layer 1 performs the light emission with its maximum output RI1(p)max. If the backlight luminance level calculating section 15 finds that LEVin_R(p,q)>LEV_RL1(p,q)max, then the backlight luminance level calculating section 15 determines that LEV_RL1(p,q)=LEV_RL1(p,q)max. If the backlight luminance level calculating section 15 finds that LEVin_R (p,q) LEV_RL1(p,q)max, then the backlight luminance level calculating section 15 determines that LEV_RL1(p,q)=LEVin_R(p,q). Based on LEV_RL1(p,q) thus determined, the backlight luminance level calculating section 15 determines lev_I2(p,q) by using the following equations:

lev_{—}RI1(p,q)=LEV_{—}RL1(p,q)/LEV_{—}RL1(p,q)max(≦1)lev_{—}RI1(p)=max(lev_{—}RI1(p,1),lev_{—}RI1(p,2), . . . ,lev_{—}RI1(p,q), . . . ,lev_{—}RI1(p,n))(≦1)

where:

LEV_RL1(p,q)max=RL1(p,q)max/RL(p,q)max,

where RL1(p,q)max is a liquid crystal display panel maximum luminance at the coordinates (p,q) on the liquid crystal display panel which maximum luminance is obtained when the R color first light source 2 for the first light guide section 1a for line p of the first light guide layer 1 performs light emission with RI1(p)max, and RL(p,q)max=RL1(p,q)max+RL2(p,q)max.

RL2(p,q)max is a liquid crystal display panel maximum luminance at the coordinates (p,q) on the liquid crystal display panel which maximum luminance is obtained when the R color second light source 4 for the second light guide section 3a for line q of the second light guide layer 3 performs light emission with RI2(q)max.

Further, the backlight luminance level calculating section 15 determines an output lev_RI2(q) of a R color second light source 4 for a second light guide section 3a for column q of the second light guide layer 3 in the following procedure.

The backlight luminance level calculating section 15 finds out which one is greater (i) the LEVin_R(p,q) extracted by the input image brightness level calculating section 14 or (ii) a luminance level (LEV_RL1(p,q)max·ev_RI1(p)) at coordinates of line p and column q of the first light guide section 1a for line q of the first light guide layer 1. If the backlight luminance level calculating section 15 finds that LEVin_R(p,q)>(LEV_RL1(p,q)max·lev_RI1(p)), then the backlight luminance level calculating section 15 determines that LEV_RL2(p,q)=LEVin_R(p,q)−(LEV_RL1(p,q)max·lev_RI1(p)). If the backlight luminance level calculating section 15 finds that LEVin_R(p,q) (LEV_RL1(p,q)max·lev_RI1(p)), then the backlight luminance level calculating section 15 determines that LEV_RL2(p,q)=0. Based on LEV_RL2(p,q) thus determined, the backlight luminance level calculating section 15 determines lev_RI2(p,q) by using the following equation:

lev_{—}RI2(p,q)=LEV_{—}RL2(p,q)/LEV_{—}RL2(p,q)max(≦1)

In the same manner, respective outputs levels lev_I1(p) and lev_I2(p,q) for the first light source 2 and the second light source 4 are determined for G and B. Then, the backlight luminance level calculating section 15 sends the output levels lev_I1(p) and lev_I2(p,q) for each of RGB to the backlight driving control section 9 of the light source driving section 6. Then, the backlight driving control section 9 controls the first light source driving circuit 7 and the second light source driving circuit 8 for independently controlling and driving the first light sources 2 and the second light sources 4, respectively. Thereby, the backlight driving control section 9 causes the first light sources 2 and the second light sources 4 to turn on via the first light source driving circuit 7 and the second light source driving circuit 8.

On the other hand, the output image luminance level calculating section 16 determines a luminance level of an output image of each color. The output image luminance level calculating section 16, which receives the signal from the input image brightness level calculating section 14, determines luminance levels of an output image (to be displayed on the liquid crystal display panel 12) by using the lev_I1(p) and lev_I2(q) determined by the backlight luminance level section 15.

The output image luminance level calculating section 16 calculates a liquid crystal display panel luminance level distribution LSF(i,j) by using the following equation:

$$LSF\_R ( i , j ) = {\sum }_{p = 1}^{m} LSF 1 ( p ) ( i , j ) max \cdot lev\_RI 1 ( p ) + {\sum }_{q = 1}^{n} LSF 2 ( q ) ( i , j ) max \cdot lev\_RI 2 ( q ) \qquad [ Math . 3 ]$$

Moreover, the output image luminance level calculating section 16 also determines a luminance level LEVout(i,j) of the output image for the liquid crystal display panel by using the following relational expression:

LEVout_{—}R(i,j)=LEVin_{—}R(i,j)·LSFmax_{—}R(i,j)/LSF_{—}R(i,j)

In this manner, the output image luminance level calculating section 16 determines the output image luminance level of each pixel. Based on the output image luminance level of each pixel, the liquid crystal display panel driving control section 17 controls the scanning signal line driving circuit 12a and the image signal line driving circuit 12b, thereby causing the liquid crystal display panel 12 to display an image thereon.

In Embodiment 1, the RGB-LED light sources, which are the first and second light sources of the backlight device, are controlled irrespectively of colors. In this case, the light emission of the backlight device is controlled only in terms of the luminance level. For example, the RGB-LED light sources of each color in the backlight are turned on even if the region at the coordinate of line p and column q in the image to be displayed is red. Meanwhile, in the configuration like the present embodiment in which the RGB-LED are adjusted on color basis, the luminance level of the backlight device is controlled on color basis. For example, if the region at the coordinate of line p and column q in the image to be displayed is red, only R-LED is turned on, and GB-LED are turned off. Thus, the red color can be displayed without deterioration in color purity by the GB-LED, thereby making it possible to display a deeper red color. Moreover, the turning-off of the GB-LED reduces the power consumption as much as the GB-LED suppose to consume when they are turned on.

### Embodiment 4

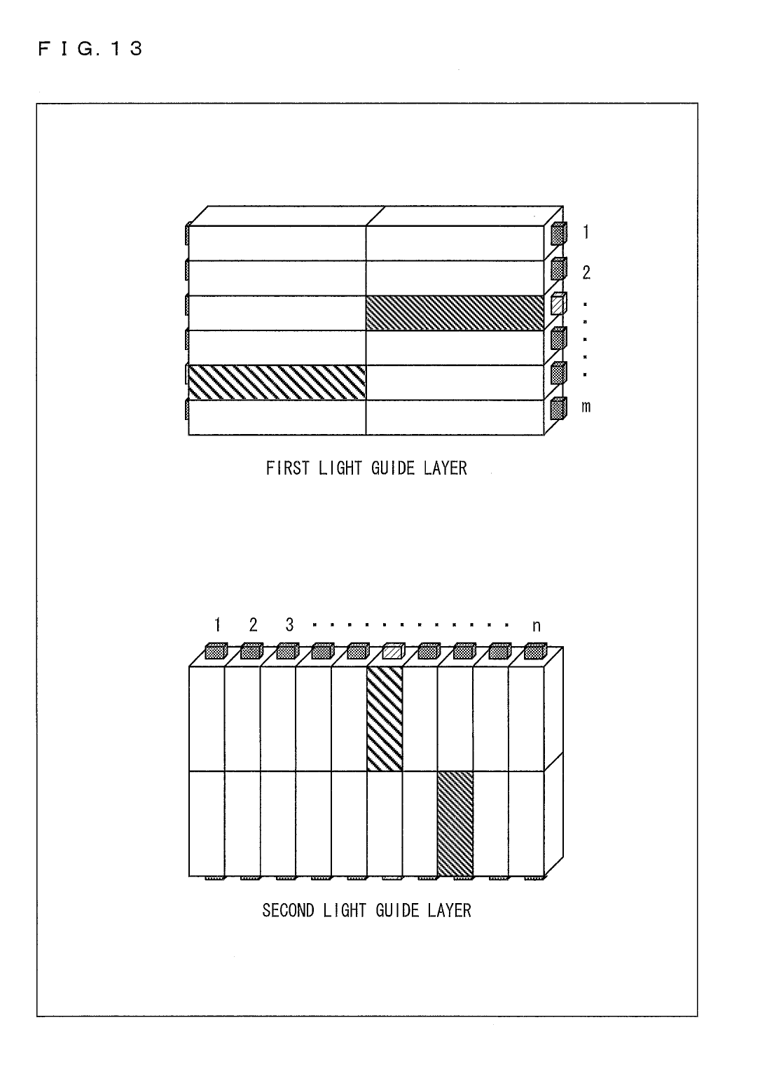

Yet another embodiment of the present invention is described below, referring to FIG. 13. In the present embodiment, only what is different from Embodiment 1 is described and the like member having the like functions as explained in Embodiment 1 are labeled in the same manner and their explanation is not repeated here, for the sake of easy explanation.

FIG. 13 is a perspective view illustrating a configuration of a first light guide layer 1 and a second light guide layer 3 provided to a backlight device in the present embodiment. The configuration of the present embodiment is different from that of Embodiment 1 in that the first and second light guide layers 1 and 3 are divided in such a manner that the first light guide sections 1a arrayed in the first light guide layer 1 are further divided in a direction crossing the array, and the second light guide sections 3a arrayed in the second light guide layer 3 are further divided in a direction crossing the array in the present embodiment. Further, in Embodiment 1, the first light guide layer 1 is provided with the first light sources 2 only along its right edge while the first light guide layer 1 in the present embodiment is provided with the first light sources 2 along both right and left edges. Likewise, in Embodiment 1, the second light guide layer 3 is provided with the second light sources 4 only along its upper edge while the second light guide layer 3 in the present embodiment is provided with the second light sources 4 along both right and left edges.

In this way, the illumination light can be controlled in a more fragmented manner by dividing the first light guide layer 1 and the second light guide layer 3 into greater numbers than in Embodiment 1. Thereby, it becomes possible to attain further higher contrast and further lower power consumption in the liquid crystal display apparatus.

### Embodiment 5

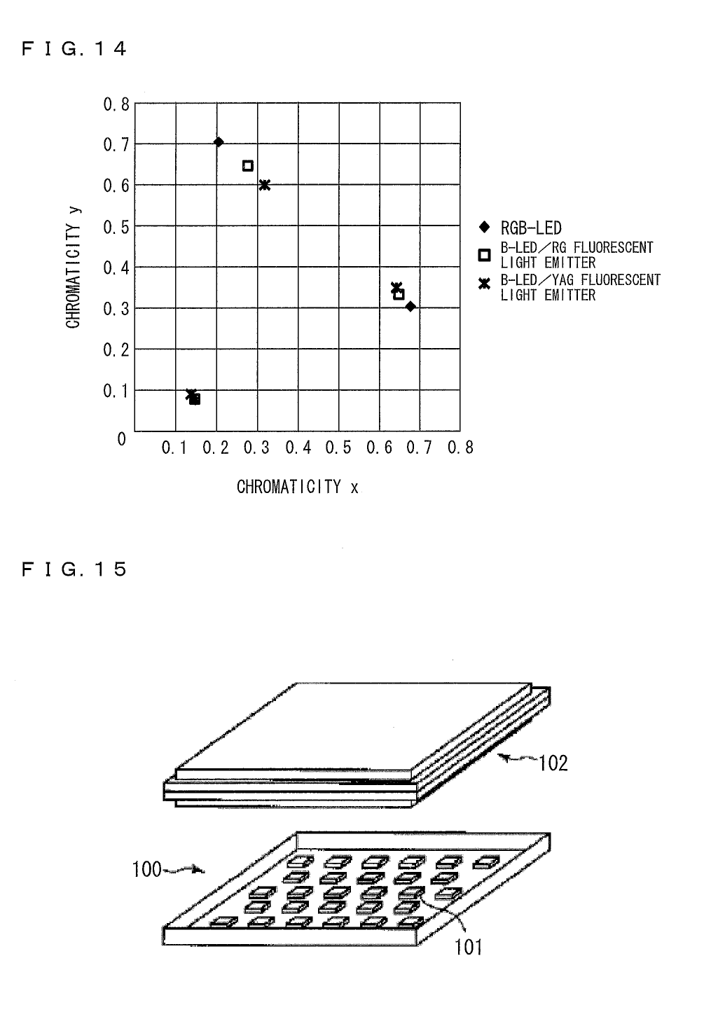

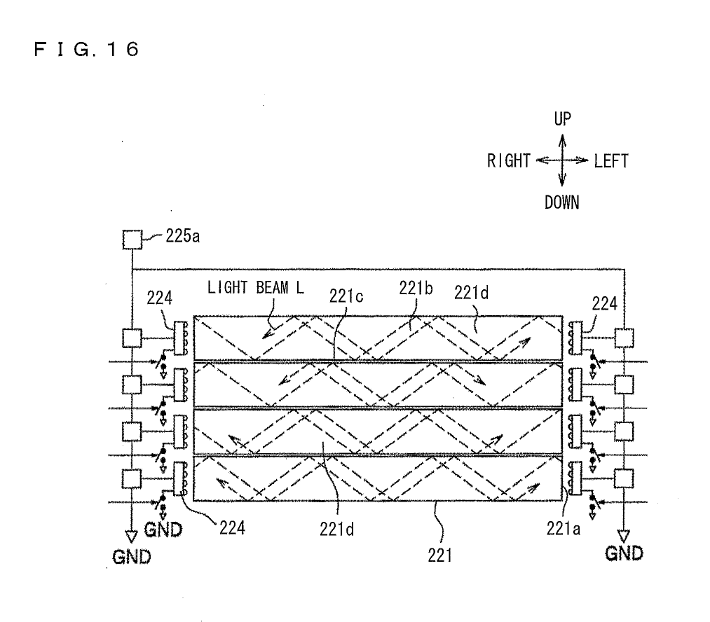

Still yet another embodiment of the present invention is described below, referring to FIG. 14. In the present embodiment, only what is different from Embodiment 1 is described and the like member having the like functions as explained in Embodiment 1 are labeled in the same manner and their explanation is not repeated here, for the sake of easy explanation.

In Embodiment 1 described above, the first light sources 2 for the first light guide layer 1 and the second light sources 4 for the second light guide layer 3 are both RGB-LED. However, in the present embodiment, second light sources 4 (see FIG. 1) are B-LED/YAG fluorescent light emitter in which yellow (Y) fluorescent light emitter (YAG fluorescent light emitter) is combined with a blue (B) LED. First light sources 2 in the present embodiment are RGB-LED. Moreover, in the present embodiment, a luminance level of the backlight device is determined by such a method that only the first light sources for the first light guide layer are turned on when an image is low in brightness level, and the second light sources for the second light guide layer are also turned on when the image is high in brightness level.

It is known that, in general, object colors present in nature are such that there is a correlation between how bright the color is (brightness) and how thick or vivid the color is (chroma saturation). For example, according to “Pointer's Color” (“The Gamut of Real Surface Colours” (COLOR research and application; Volume 5, K umber 3, Fall 1980)), object colors with high chroma saturation pare present in dark brightness regions, but the chroma saturation is decreased as the brightness becomes brighter. For example of specific colors, red, green and blue have highest chroma saturation in a relative brightness rage of 5% to about 20%. Thus, display apparatuses need high color reproduction ability in order to display an image of low brightness but, does not need such high color reproduction ability in order to display an image of high brightness.

As described above, the method according to the present embodiment for determining the luminance level of the backlight device is arranged such that only the first light sources for the first light guide layer are turned on for a region in which the brightness level of the image is low, and the second light sources for the second light guide layer are also turned on when the brightness level of the image is high.

Therefore, the first light sources for the first light guide layer is required to have a high color reproduction ability, but the second light sources for the second light guide layer does not need a color reproduction ability.

Here, at present, there are three types of LED applicable for light sources of the light guide.
RGB-LED in which the three primary colors, RED, GREEN, and BLUE are combined;
B-LED/RG fluorescent light emitter in which a BLUE LED is combined with RED and GREEN fluorescent light emitters; and
B-LED/YAG fluorescent light emitter in which a BLUE LED is combined with YELLOW fluorescent light emitter (YAG fluorescent light emitter).

As shown in Table 1, RGB-LED is high in color reproduction ability but relatively low in light emission efficiency. B-LED/YAG fluorescent light emitter is low in color reproduction ability but high in light emission efficiency. B-LED/RG fluorescent light emitter is intermediates both in color reproduction ability and light emission efficiency between RGB-LED and B-LED/YAG fluorescent light emitter.

TABLE 1

| | | B-LED/GR | B-LED/YAG |
|---|---|---|---|
| | | fluorescent | fluorescent |
| | RGB-LED | light emitter | light emitter |
| Color | 100% | 80% | 65% |
| Reproduction | | | |
| Range | | | |
| NTSC Ration | | | |
| CIE 1931 | | | |
| Light Emission | 40 to 50 | 55 to 70 | 80 to 100 |
| Efficiency | | | |
| (Im/W) | | | |

FIG. 14 illustrates chromaticity points of red, green, and blue displayed as single colors on a liquid crystal display apparatus. The horizontal axis of FIG. 14 indicates chromaticity x and the vertical axis thereof indicates chromaticity y. FIG. 14 demonstrates that different types of light sources cause different chromaticity points to be displayed, and basically chromaticity points located more outward are able to be displayed in thicker color. In FIG. 14, the triangle formed by connecting each point represents the color reproduction range. When the first light sources for the first light guide layer are RGB-LED, it is possible to secure color rendering property for images of low brightness. Moreover, when the second light sources for the second light guide layer are B-LED/YAG fluorescent light emitter, it becomes possible to secure luminance efficiently, thereby attaining low power consumption in the liquid crystal display apparatus.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

A backlight device according to the present invention is a backlight device configured to be capable of emitting light selectively from a certain part of a region, comprising: a first light guide layer having a light emitting surface on one side, and an edge section along a first direction; a second light guide layer having a light emitting surface on one side, and an edge section along a second direction perpendicular to the first direction, the first light guide layer being provided to face the light emitting surface of the second light guide layer; a plurality of first light sources arrayed along the edge section of the first light guide layer; a plurality of second light sources arrayed along the edge section of the second light guide layer; and a light source driving section for driving the first light sources independently, and driving the second light sources independently. The backlight device may be preferably configured such that it further comprises: a reflection sheet to face a surface of the second light guide layer, which surface is opposite to the light emitting surface of the second light guide layer.

With this configuration, a light beam emitted not from the light emitting surface among light beams emitted from the first light sources or the second light sources can be reflected to be returned to the first light guide layer or the second light guide layer.

In addition to any of these configurations, the backlight device according to the present invention may be preferably configured such that the first light guide layer includes a plurality of first light guide sections each having an edge section arrayed in the first direction; and the first light sources are provided to the edge sections of the first light guide sections, respectively.

With this configuration, the first light sources are associated with the first light guide sections on one-on-one basis. This makes it possible to realize light guide means of area control type.

In addition to any of these configurations, the backlight device according to the present invention may be preferably configured such that the first light guide layer has grooves on at least one of the light emitting surface thereof and a surface thereof opposite to the light emitting surface, the grooves being extended in the second direction across the first light guide from edge to edge; and the grooves define fragment regions of the first light guide layer, and each of the fragment regions of the first light guide layer is provided with at least one of the first light sources independently.

According to the configuration, the light sources are associated on one-on-one basis with the fragment regions defined by the grooves.

With this, the light can be emitted from that fragment region which corresponds to a certain light source. Thereby, light guide means of area control type can be realized.

In addition to any of these configurations, the backlight device according to the present invention may be preferably configured such that the second light guide layer includes a plurality of second light guide sections each having an edge section arrayed in the second direction; and the second light sources are provided to the edge sections of the second light guide sections.

With this configuration, the second light sources are associated with the second light guide sections on one-on-one basis. This makes it possible to realize light guide means of area control type.

In addition to any of these configurations, the backlight device according to the present invention may be preferably configured such that the second light guide layer has grooves on at least one of the light emitting surface thereof and a surface thereof opposite to the light emitting surface, the grooves being extended in the second direction across the second light guide from edge to edge; and the grooves define fragment regions of the second light guide layer, and each of the fragment regions of the second light guide layer is provided with corresponding one of the second light sources.

According to the configuration, the second light sources are associated on one-on-one basis with the fragment regions defined by the grooves.

With this, the light can be emitted from that fragment region which corresponds to a certain second light source. Thereby, light guide means of area control type can be realized.

In addition to any of these configurations, the backlight device according to the present invention may be preferably configured such that the first light guide sections of the first light guide layer are arrayed in two rows lined up in the second direction across the first light guide layer from edge to edge.

In the configuration, the first light guide layer is not only divided in the first direction but also divided into two in the second direction.

This makes it possible to realize a more fragmented area control, thereby leading to contrast improvement and lower power consumption.

In addition to any of these configurations, the backlight device according to the present invention may be preferably configured such that the second light guide sections of the second light guide layer are arrayed in two rows lined up in the first direction across the second light guide layer from edge to edge.

In the configuration, the second light guide layer is not only divided in the second direction but also divided into two in the first direction.

This makes it possible to realize a more fragmented area control, thereby leading to contrast improvement and lower power consumption.

In addition to any of these configurations, the backlight device according to the present invention may be preferably configured such that the first light sources are light emitting diodes (RGB-LED) in which three primary colors, red (R), green (G), and blue (B), are combined.

Such a light emitting diode (RGB-LED) in which the three primary colors red (R), green (G), and blue (B) are combined is high in color reproduction ability but relatively low in light emission efficiency.

Therefore, the configuration in which the first light sources are RGB-LED makes it possible to secure high color rendering property in an image of low brightness.

In addition to any of these configurations, the backlight device according to the present invention may be preferably configured such that the second light sources are light sources in which a blue (B) light emitting diode (B-LED) is combined with a fluorescent light emitter.

The B-LED/fluorescent light emitter in which blue (B) light emitting diode (B-LED) is combined with a fluorescent light emitter is low in color reproduction ability but high in light emission efficiency. Especially, it is preferable that the fluorescent light emitter is a yellow (Y) fluorescent light emitter (YAG fluorescent light emitter), because the light emission efficiency attained thereby is high.

Thus, the configuration in which the second light sources are B-LED/YAG fluorescent light emitter makes it possible to efficiently secure luminance, thereby contributing to lower power consumption of the image display apparatus.

Moreover, the present invention encompasses an image display apparatus comprising: a backlight device having any of these configurations; and a display panel.

Moreover, an image display apparatus according to the present invention is an image display apparatus comprising: a backlight device having any one of the aforementioned configurations; and a display panel provided to face the light emitting surface of the first light guide layer of the backlight device, the image display apparatus further comprising: control section for controlling light emission of the first light sources and the second light sources of the backlight device, the control section including: an input image brightness level calculating section for determining brightness levels of an input image; and a backlight luminance level calculating section for determining output levels of the first light sources and second light sources, the backlight luminance level calculating section being configured to calculate each of light emission intensities of the first light sources and the second light sources according to the brightness levels of the input image, respectively.

It is so arranged that, each of the first light sources is RGB-LED and each of the second light sources is B-LED/fluorescent light emitter, the first light, and that for a region in which the brightness level of the input is lower than the thus determined value among all fragment regions of the input image, the backlight luminance level calculating section turns on a first light source corresponding to this region, and for a region in which the brightness level of the input is higher than the predetermined value, the backlight luminance level calculating section turns on a first light source and a second light source corresponding to this region. This configuration makes it possible to secure high color rendering property in an image region of low brightness, and to secure luminance efficiently in an image region of high brightness.

In addition to the any of these configuration, the image display apparatus according to the present invention may be preferably configured such that the first direction of the first light guide layer in the backlight device is an up-down direction (vertical direction) of the image display apparatus; the second direction of the second light guide layer in the backlight device is a right-left direction (horizontal direction) of the image display apparatus; and the control section intermittingly turns on and off the first light sources in synchronism with scanning of the display panel.

The intermitted light emission of the first light source in synchronism with the scanning of the display panel improves the liquid crystal display apparatus in terms of moving image display performance. In this configuration, the illumination light from the second light guide layer does not contribute to the moving image display performance of the liquid crystal display apparatus. Thus, it is preferably configured such that the backlight luminance level calculating section causes the first light sources to turn on but causes the second light sources to turn off for regions in which the brightness level of the input image is lower than the predetermined value, whereas, for regions in which the brightness level of the input image is higher than the predetermined value, the backlight luminance level calculating section causes the first light sources and the second light sources to turn on.

In a configuration in which the first light guide layer is provided to face the light emitting surface of the second light guide layer, and the display panel is provided to face the light emitting surface of the first light guide layer, so that the light emitted from the first light guide layer enter the display panel from behind of the display panel, the intermitted light emission of the first light source in synchronism with the scanning of the display panel further improves the liquid crystal display apparatus in terms of moving image display performance.

This is because the moving picture display performance of the liquid crystal display apparatus can be further improved when the illumination light from the vertically fragmented regions in the first light guide layer has a greater optical independency.

In addition to any of the aforementioned configurations, the image display apparatus according to the present invention may be preferably configured such that the control section further includes an output image luminance level calculating section for determining luminance levels of an output image to be displayed on the display panel; and the output image luminance level calculating section is configured to determines the luminance levels of the output image on the basis of the output levels of the first light sources and the second light sources determined by backlight luminance level calculating section.

With this configuration, it becomes possible for the liquid crystal display apparatus to reproduce and display an input image with higher contrast.

A method according to the present invention is a driving method for driving the first light sources and the second light sources provided in the image display apparatus as set forth in any one of claims 12 to 15, the method comprising: a step (A) for calculating brightness levels of red (R), green (G), and blue (B) in a fragment region (p, q) among an m×n number of fragment regions obtained by dividing an input image in the first direction into an m number of the first light sources (m≧2), and in the second direction into an n number of the second light sources (n≧2); a step (B) for determining an output level lev_I1(p) of that one of the first light sources which is provided for a line-p fragment region corresponding to line p and including the fragment region (p, q) among fragment regions for an m number of lines obtained by dividing the first light guide layer in the first direction into the m number of the first light sources (m≧2); and a step (C) for determining an output level lev_I2(q) of that one of the second light sources which is provided for a line-q fragment region corresponding to line q and including the fragment region (p, q) among fragment regions for an n number of lines obtained by dividing the second light guide layer in the second direction into the n number of the second light sources (n≧2), the step (C) for determining that the output level lev_I2(q)=0, if the LEVin(p,q) obtained by the step (A) an integration of a liquid crystal display panel maximum luminance level LEV_L1(p,q)max and the output level lev_I1(p) determined by the step B, where the liquid crystal display panel maximum luminance level LEV_L1(p,q)max is a maximum luminance level at the region (p, q) on the display panel, which maximum luminance level LEV_L1(p,q)max is obtained when the first light source for the line p of the first light guide layer performs light emission with a maximum output of the first light source. It is preferable that the method further comprises a step (D) for determining luminance levels of the output image to be displayed on the display panel, the step (D) determining the luminance levels of the output image on the basis of the output levels lev_I1(p) and lev_I2(q).

With this configuration, it becomes possible for the liquid crystal display apparatus to reproduce and display an input image with higher contrast.

It is to be understood that the embodiments and examples described above are not intended to be exhaustive nor limiting of the invention, but, on the contrary, are give for purposes of illustration in order that others skilled in the art may fully understand the technical contents of the invention, and that the present invention Such variations are not to be regarded as a departure from the spirit and scope of the invention, and all such modifications as would be obvious to one skilled in the art are intended to be included within the scope of the following claims.

### INDUSTRIAL APPLICABILITY

The present invention has such a high industrial applicability that it is applicable to, most suitably, backlight devices of display apparatuses, and to display apparatuses.

### REFERENCE SIGNS LIST

1, 1′: First Light Guide Layer
1a: First Light Guide Section
2, 2′: First Light Source
3: Second Light Guide Layer
3a: Second Light Guide Section
4: Second Light Source
5: Reflection Sheet
6: Light Source Driving Section
7: First Light Source Driving Circuit
8: Second Light Source Driving Circuit
9: Backlight Driving Control Section
10: Backlight Device
11: Optical Sheet Section
12: Liquid Crystal Display Panel (Display Panel)
12a: Scanning Signal Line Driving Circuit
12b: Image Signal Line Driving Circuit
13: Control Device (Control Section)
14: Input Image Brightness Level Calculating Section
15: Backlight Luminance Level Calculating Section
16: Output Image Luminance Level Calculating Section
17: Liquid Crystal Display Panel Driving Control Section
18: Groove
20: Liquid Crystal Display Apparatus

1. A backlight device configured to be capable of emitting light selectively from a certain part of a region, comprising:
a first light guide layer having a light emitting surface on one side, and an edge section along a first direction;
a second light guide layer having a light emitting surface on one side, and an edge section along a second direction perpendicular to the first direction, the first light guide layer being provided to face the light emitting surface of the second light guide layer;
a plurality of first light sources arrayed along the edge section of the first light guide layer;
a plurality of second light sources arrayed along the edge section of the second light guide layer; and
a light source driving section for driving the first light sources independently, and driving the second light sources independently.

2. The backlight device as set forth in claim 1, further comprising:
a reflection sheet to face a surface of the second light guide layer, which surface is opposite to the light emitting surface of the second light guide layer.

3. The backlight device as set forth in claim 1, wherein:
the first light guide layer includes a plurality of first light guide sections each having an edge section arrayed in the first direction; and
the first light sources are provided to the edge sections of the first light guide sections, respectively.

4. The backlight device as set forth in claim 1, wherein:
the first light guide layer has grooves on at least one of the light emitting surface thereof and a surface thereof opposite to the light emitting surface, the grooves being extended in the second direction across the first light guide from edge to edge; and
the grooves define fragment regions of the first light guide layer, and each of the fragment regions of the first light guide layer is provided with at least one of the first light sources independently.

5. The backlight device as set forth in claim 1, wherein:
the second light guide layer includes a plurality of second light guide sections each having an edge section arrayed in the second direction; and
the second light sources are provided to the edge sections of the second light guide sections.

6. The backlight device as set forth in claim 1, wherein:
the second light guide layer has grooves on at least one of the light emitting surface thereof and a surface thereof opposite to the light emitting surface, the grooves being extended in the second direction across the second light guide from edge to edge; and
the grooves define fragment regions of the second light guide layer, and each of the fragment regions of the second light guide layer is provided with corresponding one of the second light sources.

7. The backlight device as set forth in claim 3, wherein the first light guide sections of the first light guide layer are arrayed in two rows lined up in the second direction across the first light guide layer from edge to edge.

8. The backlight device as set forth in claim 5, wherein the second light guide sections of the second light guide layer are arrayed in two rows lined up in the first direction across the second light guide layer from edge to edge.

9. The backlight device as set forth in claim 1, wherein the first light sources are light emitting diodes (RGB-LED) in which three primary colors, red (R), green (G), and blue (B), are combined.

10. The backlight device as set forth in claim 1, wherein the second light sources are light sources in which a blue (B) light emitting diode (B-LED) is combined with a fluorescent light emitter.

11. An image display apparatus comprising:
a backlight device as set forth in claim 1; and
a display panel.

12. An image display apparatus comprising:
a backlight device as set forth in claim 1; and
a display panel provided to face the light emitting surface of the first light guide layer of the backlight device,
the image display apparatus further comprising:
a control section for controlling light emission of the first light sources and the second light sources of the backlight device,
the control section including:
an input image brightness level calculating section for determining brightness levels of an input image; and
a backlight luminance level calculating section for determining output levels of the first light sources and second light sources,
the backlight luminance level calculating section being configured to calculate each of light emission intensities of the first light sources and the second light sources according to the brightness levels of the input image, respectively.

13. The image display apparatus as set forth in claim 12, wherein:
for a region in which the brightness level of the input is lower than the thus determined value among all fragment regions of the input image, the backlight luminance level calculating section turns on a first light source corresponding to this region, and for a region in which the brightness level of the input is higher than the predetermined value, the backlight luminance level calculating section turns on a first light source and a second light source corresponding to this region.

14. The image display apparatus as set forth in claim 12, wherein:
the first direction of the first light guide layer in the backlight device is an up-down direction of the image display apparatus;
the second direction of the second light guide layer in the backlight device is a right-left direction of the image display apparatus; and
the control section intermittingly turns on and off the first light sources in synchronism with scanning of the display panel.

15. The image display apparatus as set forth in claim 12, wherein:
the control section further includes an output image luminance level calculating section for determining luminance levels of an output image to be displayed on the display panel; and
the output image luminance level calculating section is configured to determines the luminance levels of the output image on the basis of the output levels of the first light sources and the second light sources determined by backlight luminance level calculating section.

16. A driving method for driving the first light sources and the second light sources provided in the image display apparatus as set forth in claim 12, the method comprising:
a step (A) for calculating brightness levels LEVin(p,q) of red (R), green (G), and blue (B) in a fragment region (p, q) among an m×n number of fragment regions obtained by dividing an input image in the first direction into an m number of the first light sources (m≧2), and in the second direction into an n number of the second light sources (n≧2);
a step (B) for determining an output level lev_I1(p) of that one of the first light sources which is provided for a line-p fragment region corresponding to line p and including the fragment region (p, q) among fragment regions for an m number of lines obtained by dividing the first light guide layer in the first direction into the m number of the first light sources (m≧2); and
a step (C) for determining an output level lev_I2(q) of that one of the second light sources which is provided for a line-q fragment region corresponding to line q and including the fragment region (p, q) among fragment regions for an n number of lines obtained by dividing the second light guide layer in the second direction into the n number of the second light sources (n≧2),
the step (C) for determining that the output level lev_I2(q)=0, if the LEVin(p,q) obtained by the step (A) a liquid crystal display panel maximum luminance level LEV_L1(p,q)max×the output level lev_I1(p) determined by the step B, where the liquid crystal display panel maximum luminance level LEV_L1(p,q)max is a maximum luminance level at the region (p, q) on the display panel, which maximum luminance level LEV_L1(p,q)max is obtained when the first light source for the line p of the first light guide layer performs light emission with a maximum output of the first light source.

17. The method as set forth in claim 16, further comprising:
a step (D) for determining luminance levels of the output image to be displayed on the display panel,
the step (D) determining the luminance levels of the output image on the basis of the output levels lev_I1(p) and lev_I2(q).
